(19) United States
(12) Patent Application Publication
(10) Pub. No.: US 2001/0028786 A1
(43) Pub. Date: Oct. 11, 2001

(54) RECORDING APPARATUS AND METHOD, REPRODUCING APPARATUS AND METHOD, RECORDING /REPRODUCING APPARATUS AND METHOD, STORAGE MEDIUM AND PROGRAM OFFERING MEDIUM

(76) Inventors: TOSHIYA HAMADA, SAITAMA (JP); YASUSHI FUJINAMI, TOKYO (JP)

Correspondence Address: FROMMER LAWRENCE & HAUG, 745 FIFTH AVENUE- 10TH FL., NEW YORK, NY, 10151, US

(21) Appl. No.: 09/175,114

(22) Filed: Oct. 19, 1998

(30) Foreign Application Priority Data
Oct. 21, 1997 (JP) 9-288180
Feb. 27, 1998 (JP) 10-046857
Apr. 30, 1998 (JP) 10-120390

(51) Int. Cl. H04N 5/783; G11B 17/22; G11B 3/74; G11B 7/20

(52) U.S. Cl. 386/69; 369/95

(57) ABSTRACT

A field mark_type is provided within title_info( ) to set a kind of mark and moreover the time having passed from the leading area of title is set to relative_time_stamp_in_title. Thereby many kinds of indices can be recorded without limitation on the format.

### BACKGROUND OF THE INVENTION

1. Field of the Invention

The present invention relates to a recording apparatus and method, a reproducing apparatus and method, a recording/reproducing apparatus and method, a storage medium and a program offering medium and particularly to a recording apparatus and method, a reproducing apparatus and method, a recording/reproducing apparatus and method, a storage medium and a program offering medium which realize recording or reproducing of many kinds of indices without any limitation of format.

2. Description of the Related Art

An optical disk represented by CD-ROM is provided for many users to record a variety of data because of its large recording capacity and is offered to users for application thereof. CD-ROM is used only for reproduction, but recently an optical disk which realizes additional writing and over-writing of data has been developed and is spreading.

It is possible to record an index information to these optical disks as a queue mark. However, the optical disk of the related art has a problem that it does not allow the recording of many kinds of indices because of restriction from the viewpoint of format.

### SUMMARY OF THE INVENTION

The present invention has been proposed considering the background explained above and it is now possible, according to the present invention, to record many kinds of indices without restriction of the format.

According to a profile of the present invention, a recording apparatus comprises a position designating means for designating position of the information recorded in a storage medium, a kind designating means for designating a kind of the position designated by the position designating means and a recording means for recording, to a storage medium, the position designated by the position designating means and the kind designated by the kind designating means.

According to another profile of the present invention, a recording method comprises a position designating step for designating a position of information recorded on a storage medium, a kind designating step for designating a kind of the position designated by the position designating step and a recording step for recording, to a storage medium, the position designated by the position designating step and the kind designated by the kind designating step.

According to the other profile of the present invention, a program offering medium can offer, to a recording apparatus for recording information to a storage medium, a program to be read by a computer to execute the processes including the position designating step for designating the position of the information recorded to the storage medium, the kind designating step for designating the kind of position designated by the position designating step and the recording step for recording, to the storage medium, the position designated by the position designating step and the kind designated by the kind designating step.

According to the other profile of the present invention, a reproducing apparatus comprises a reproducing means for reproducing, from a storage medium, the position designating information for designating the position of information recorded to the storage medium and the kind designating information for designating the kind of position designated by the position designating information and a control means for controlling reproduction of information from the storage medium corresponding to the position designating information and kind designating information reproduced by the reproducing means.

According to the other profile of the present invention, a reproducing method comprises a reproducing step for reproducing, from the storage medium, the position designating information for designating the position of information recorded in the storage medium and the kind designating information for designating the kind of position designated by the position designating information and a control step for controlling reproduction of the information from the storage medium corresponding to the position designating information and kind designating information reproduced in the reproducing step.

According to the other profile of the present invention, a program offering medium can offer, to a reproducing apparatus for producing information from a storage medium, a program to be read by a computer to execute the processes including the reproducing step for reproducing, from the storage medium, the position designating information for designating the position of information recorded to the storage medium and the kind designating information for designating the kind of position designated by the position designating information and a control step for controlling reproduction of information from the storage medium corresponding to the position designating information and kind designating information reproduced in the reproducing step.

According to the other profile of the present invention, a recording/reproducing apparatus comprises a recording means for recording, to a storage medium, the position designating information for designating the position of information stored in the storage medium and the kind designating information for designating the kind of position designated by the position designating information, a reproducing means for reproducing, from the storage medium, the position designating information and kind designating information recorded in the storage medium and a control means for controlling reproduction of the information from the storage medium corresponding to the position designating information and kind designating information reproduced by the reproducing means.

According to the other profile of the present invention, a recording/reproducing method comprises a recording step for recording, to a storage medium, the position designating information for designating the position of information recorded in the storage medium and the kind designating information for designating the kind of position designated by the position designating information, a reproducing step for reproducing, from the storage medium, the position designating information and kind designating information stored in the storage medium and a control step for controlling reproduction of information from the storage medium corresponding to the position designating information and kind designating information reproduced in the reproducing step.

According to the other profile of the present invention, a program offering medium can offer, to the recording/reproducing apparatus for recording or reproducing information to/from a storage medium, a program to be read by a computer to execute the processes comprising a recording step for recording, to the storage medium, the position designating information for designating the position of information recorded to the storage medium and the kind designating information for designating the kind of position designated by the position designating information, a reproducing step for reproducing, from the storage medium, the position designating information and kind designating information stored in the storage medium and a control step for controlling reproduction of information from the storage medium corresponding to the position designating information and kind designating information reproduced in the reproducing step.

According to the other profile of the present invention, a storage medium has completed the recording of the position designating information for designating the position of information and the kind designating information for designating the kind of position designated by the position designating information.

According to the other profile of the present invention, in the recording apparatus and method and the program offering medium, position and kind of the information are recorded in a storage medium.

According to the other profile of the present invention, in the reproducing apparatus and method and the program offering medium, the position designating information and kind designation information recorded to the storage medium are reproduced, and reproduction of control from the storage medium can be controlled corresponding to the reproduced position designating information and kind designating information.

According to the other profile of the present invention, in the recording/reproducing apparatus and method and program offering medium, the position designating information for designating the position of information recorded to the storage medium and kind designating information for designating the kind of position designated by the position designating information are recorded to the storage medium and reproduction of information from the storage medium is controlled corresponding to the position designating information and kind designating information reproduced from the storage medium.

According to the other profile of the present invention, the position designating information for designating the position of information and the kind designating information for designating the position of information designated by the position designating information are recorded in the storage medium.

### BRIEF DESCRIPTION OF THE DRAWING

Other objects and advantages of the present invention will be apparent from the following detailed description of the presently preferred embodiments thereof, which description should be considered in conjunction with the accompanying drawings in which:

FIG. 1 is a diagram for explaining a format of directory;

FIG. 2 is a diagram for explaining VOLUME.TOC;

FIG. 3 is a diagram for explaining volume_information ( );

FIG. 4 is a diagram for explaining volume_attribute( );

FIG. 5 is a diagram for explaining resume( );

FIG. 6 is a diagram for explaining volume_rating( );

FIG. 7 is a diagram for explaining write_protect( );

FIG. 8 is a diagram for explaining play_protecto( );

FIG. 9 is a diagram for explaining recording_timer( );

FIG. 10 is a diagram for explaining text_blocko( );

FIG. 11 is a diagram for explaining language_set( )( );

FIG. 12 is a diagram for explaining test_itemo( );

FIG. 13 is a diagram for explaining ALBUM.STR( );

FIG. 14 is a diagram for explaining albumo( );

FIG. 15 is a diagram for explaining TITLE_###.VDR;

FIG. 16 is a diagram for explaining title_info( );

FIG. 17 is a diagram for explaining PROGRAM_$$$.PGI;

FIG. 18 is a diagram for explaining programs( );

FIG. 19 is a diagram for explaining play_list( );

FIG. 20 is a diagram for explaining play_item( );

FIG. 21 is a diagram for explaining CHUNKGROUP_###. CGIT;

FIG. 22 is a diagram for explaining chunk_connection_info( );

FIG. 23 is a diagram for explaining chunk_arrangement_info( );

FIG. 24 is a diagram for explaining CHUNK_%%%%.ABST;

FIG. 25 is a block diagram showing a structure example of an optical disk apparatus to which the present invention is applied;

FIG. 26 is a diagram for explaining a structure of directory;

FIG. 27 is a diagram for explaining a logical structure of directory;

FIG. 28 is a diagram for explaining offset;

FIG. 29 is a diagram for explaining a structure of directory;

FIG. 30 is a diagram for explaining a structure of directory;

FIG. 31 is a diagram for explaining a logical structure of directory;

FIG. 32 is a diagram for explaining a structure of directory;

FIG. 33 is a diagram for explaining a structure of directory;

FIG. 34 is a diagram for explaining a logical structure of directory;

FIG. 35 is a diagram for explaining a logical structure of directory;

FIG. 36 is a diagram for explaining file_type_id;

FIG. 37 is a diagram for explaining mark_type;

FIG. 38 is a diagram for explaining file_type_id;

FIG. 39 is a diagram for explaining chunk_sync_play_flag;

FIG. 40 is a diagram for explaining original_time_count_type;

FIG. 41 is a diagram for explaining file_type_id;

FIG. 42 is a diagram for explaining info_type;

FIG. 43 is a diagram for explaining slot_unit_type;

FIG. 44 is a flowchart for explaining the mark registration process;

FIG. 45 is a diagram for explaining mark position;

FIG. 46 is a flowchart for explaining the queue process using a mark;

FIG. 47 is a flowchart for explaining the skip reproducing process; and

FIG. 48 is a diagram for explaining the skip reproducing process.

### DESCRIPTION OF THE PREFERRED EMBODIMENTS

Preferred embodiments of the present invention will be explained below. In this case, characteristics of the present invention will be explained by indicating the corresponding embodiment (only an example) to the parentheses after each means in order to make clear the correspondence between each means of the present invention and the preferred embodiment. However, it does not suggest that the present invention is limited to each means described.

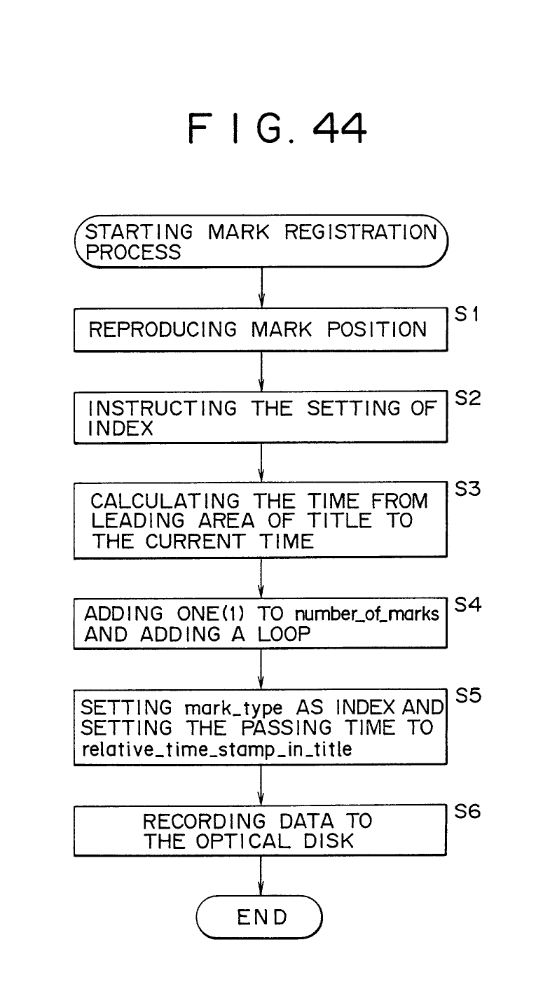

A recording apparatus of the present invention is characterized in comprising a position designating means (for example, relative_time_stamp_in_title of FIG. 16) for designating the position of information recorded to a storage medium, a kind designating means (for example, mark_type in FIG. 16) for designating the kind of information designated by the position designating means and a storing means (for example, step S6 in FIG. 44) for recording, to a storage medium, the position designated by the position designating means and the kind designated by the kind designating means.

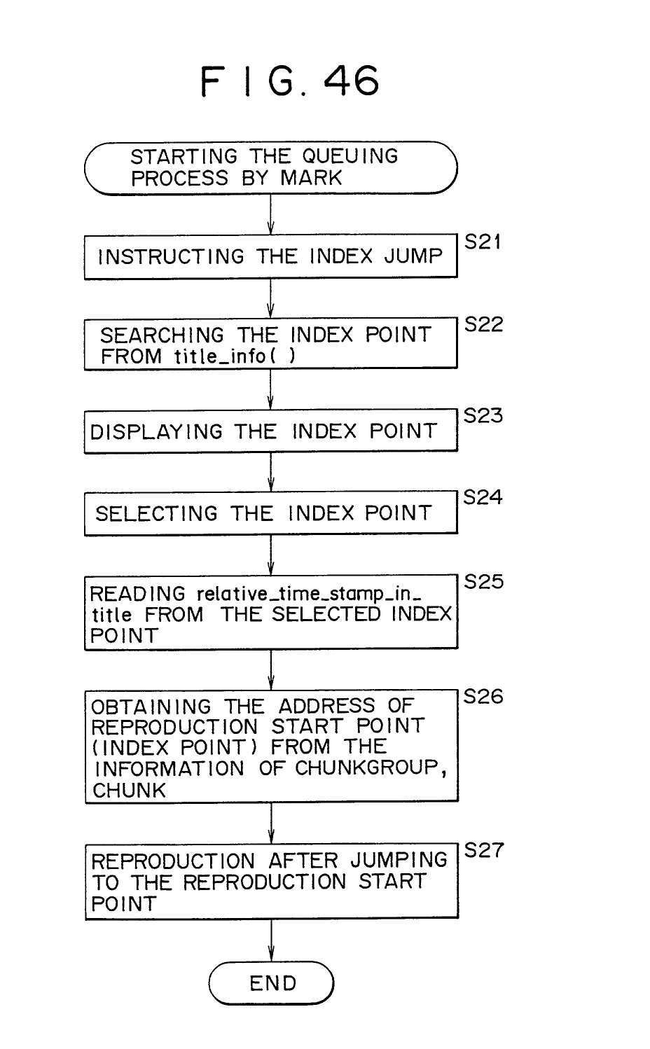

A reproducing apparatus of the present invention is characterized in comprising a reproducing means (for example, step S22 in FIG. 46) for reproducing, from the storage medium, the position designating information (for example, relative_time_stamp_in_title in FIG. 16) for designating the position of information recorded in the storage medium and the kind designating information (for example, mark_type in FIG. 16) for designating the kind of information designated by the position designating information and a control means (for example, step S27 in FIG. 46) for controlling reproduction of information from the storage medium corresponding the position designating information and kind designating information reproduced by the reproducing means.

A recording/reproducing apparatus of the present invention is characterized in comprising a recording means (for example, step S6 of FIG. 44) for recording, to the storage medium, the position designating information (for example, relative_time_stamp in title of FIG. 16) for designating the position of information recorded to the storage medium and the kind designating information (for example, mark_type of FIG. 16) for designating the kind of information designated by the position designating information, a reproducing means (for example, step S22 of FIG. 46) for reproducing, from the storage medium, the position designating information and kind designating information recorded in the storage medium and a control means (for example, step S27 of FIG. 46) for controlling reproduction of information from the storage medium corresponding to the position designating information and kind designating information reproduced by the reproducing means.

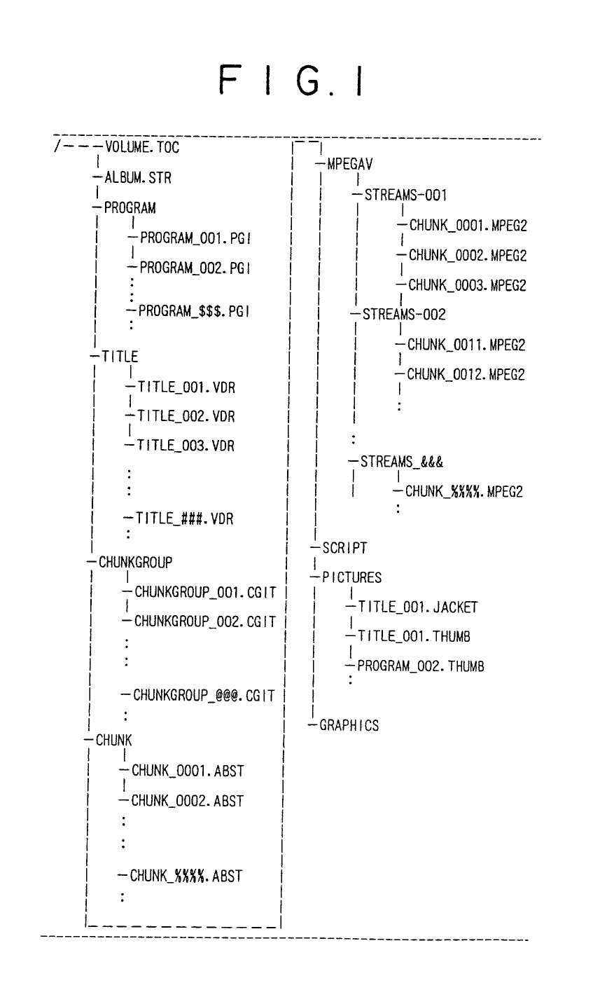

File allocation on a storage medium (media) to or from which information is recorded for reproduced in the present invention will be explained first. As shown in FIG. 1, following seven kinds of files are recorded on a medium.

VOLUME.TOC

ALBUM.STR

PROGRAM_$$$.PGI

TITLE_###.VDR

CHUNKGROUP_@@@.CGIT

CHUNK_%%%%.ABST

CHUNK_%%%%.MPEG2

The files VOLUME. TOC and ALBUM. STR are placed in a root directory. Moreover, “PROGRAM_$$$.PGI” (here, “$$$” indicates a program number) is placed in the directory “PROGRAM” just under the root directory. Similarly, “TITLE_###.VDR” (here, “###” indicates a title number) is placed in the directory “TITLE” just under the root directory, while “CHUNKGROUP_@@@.CGIT” (here, @@@ indicates a chunk group number) to the directory “CHUNKGROUP” and “CHUNK_%%%%.ABST” (here, “%%%%” indicates a chunk number) is placed in the directory “CHUNK”, respectively.

Moreover, one or more sub-directories are generated to the MPEGAV directory just under the root directory and “CHUNK_%%%%.MPEG2” (here, %%%% indicates a chunk number) is placed under the sub-directories.

One file VOLUME.TOC is usually placed on a medium. However, a plurality of files VOLUME.TOC are also placed in some cases on a particular medium of the hybrid structure of ROM and RAM. This file is used to indicate the property of the medium as a whole.

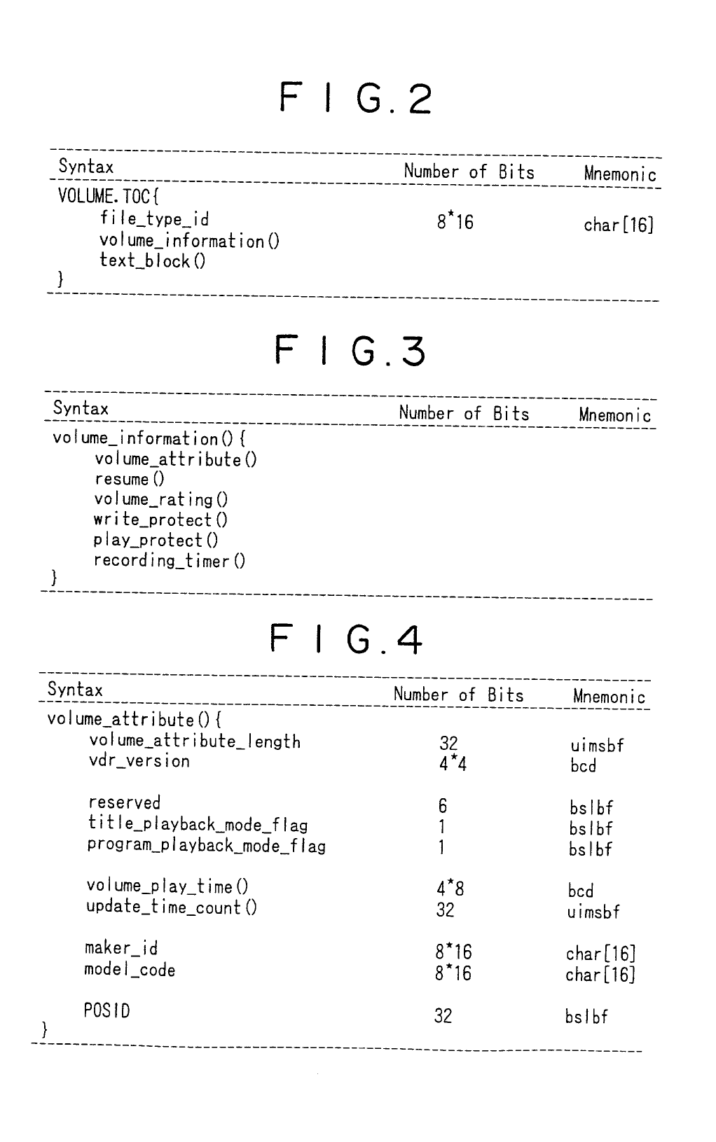

The file VOLUME.TOC has a structure shown in FIG. 2 The leading are “file_type_id” is placed first to indicate the relevant file is VOLUME.TOC. This area is followed by the area “volume_information( )” and the area “text_block( )” as the final area.

Structure of the “volumne_information( )” is shown in FIG. 3. This area includes the areas “volume_attribute( )”, “resume( )”, “volume_rating( )”, “write_protect( )”, “play_protect( )” and “recording_timer( )”.

The “volume_attribute( )” is provided to record the attribute of logical volume and the detail structure of this area is shown in FIG. 4. As shown in this figure, this area includes “title_playback_mode_flag” , “program_playback_mode_flag”, etc.

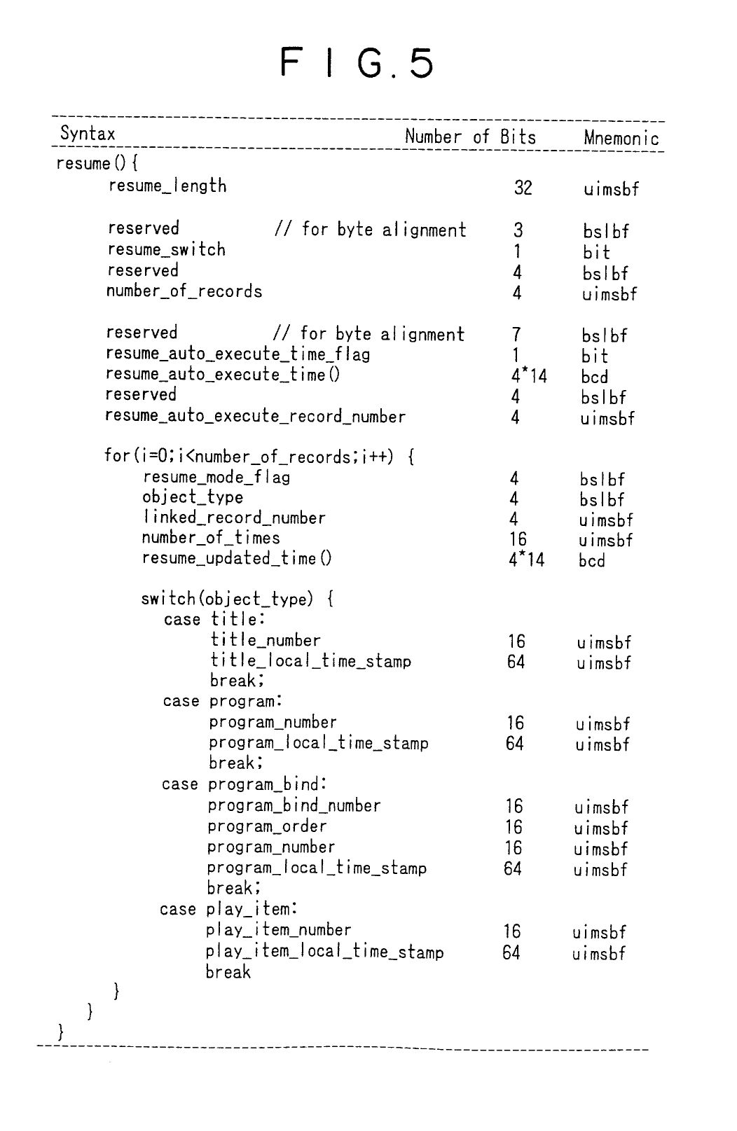

The area “resume( )” is provided to record information to recover the condition immediately before eject at the time of re-insertion of a medium. Detail structure of this area is shown in FIG. 5.

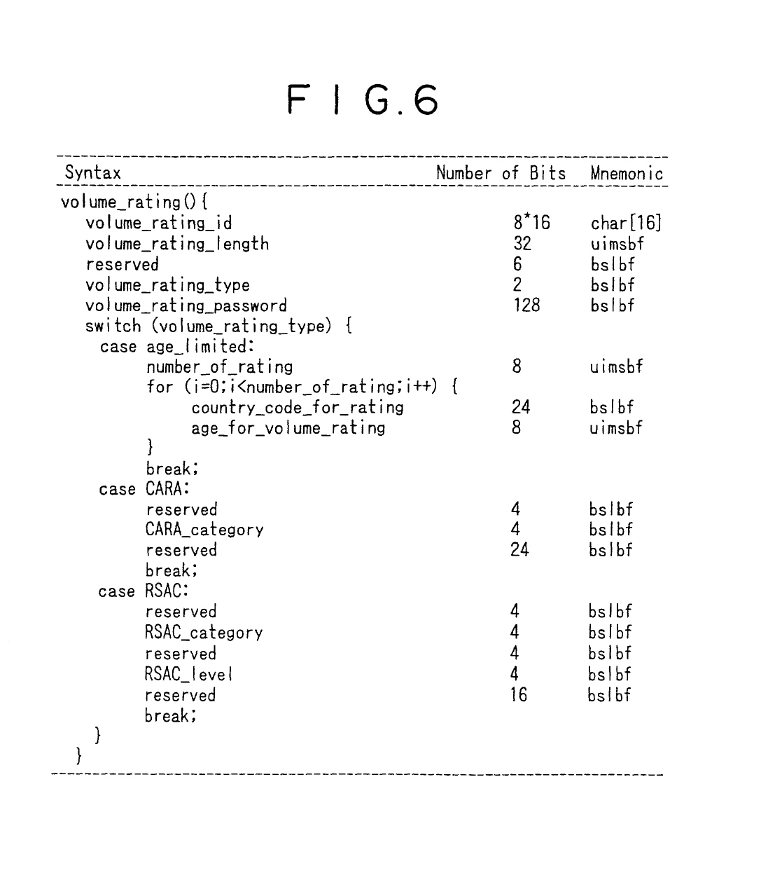

The area “volume_rating( )” of FIG. 3 is provided to record the information to realize age limitation of viewers for the whole volume depending on the age and category and detail structure is shown in FIG. 6.

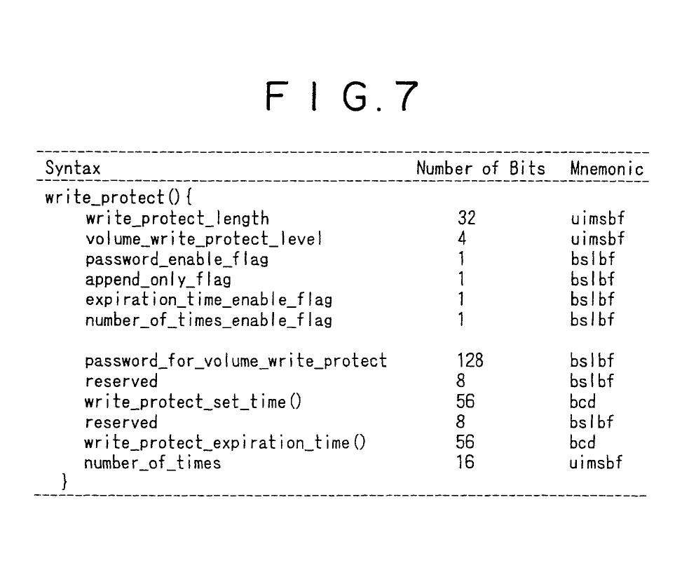

The area “write_protect( )” of FIG. 3 is used to record the information for limiting change and erasing manipulation for title and program recorded in the volume. Detail structure of this area is shown in FIG. 7.

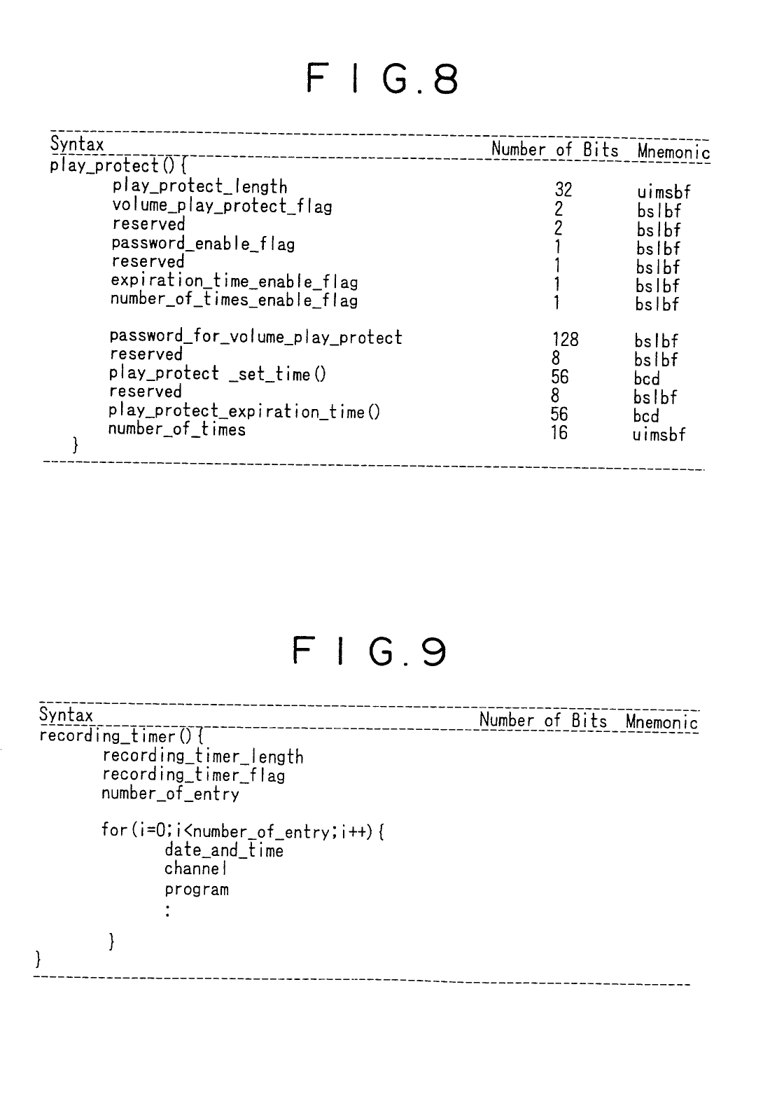

The area “play_protect( )” of FIG. 3 is used to record the information for setting of reproduction acknowledgment, inhibition of reproduction or the information for limiting number of times of reproduction for the title and program recorded in the volume. Detail structure of this area is shown in FIG. 8.

The area “recording_timer( )” of FIG. 3 is used to record the information for controlling the recording time. Detail structure of this area is shown in FIG. 9.

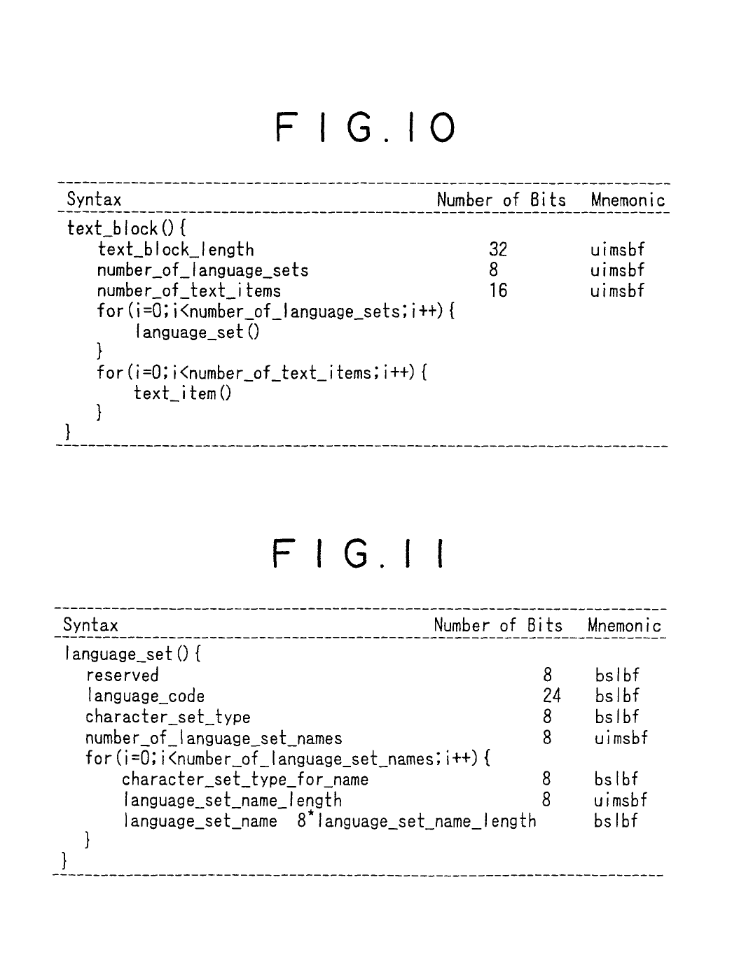

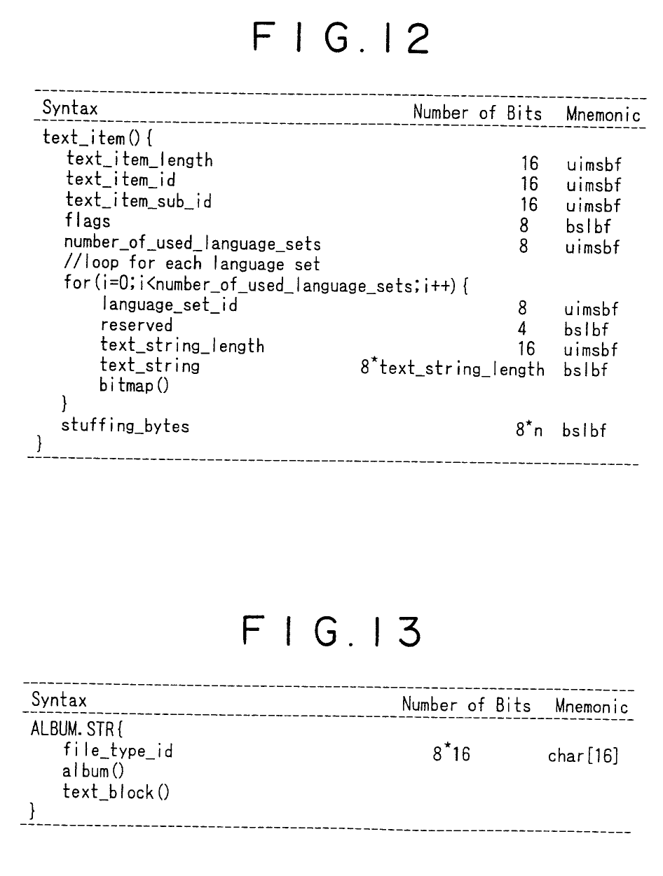

Detail structure of the area “text_block( )” of the file VOLUME.TOC of FIG. 2 is shown in FIG. 10. This area “text_block( )” includes the areas “language set” and “text_item”. Detail structure of these areas are respectively shown in FIG. 11 and FIG. 12.

Usually, a medium includes one ALBUM. STR file shown in FIG. 1. However, it is also possible that a plurality of files exist in the medium having the particular structure such as the media having hybrid structure of ROM and RAM. This file is used in combination with a plurality of media to form a structure which can be seen as if it is formed of only one medium.

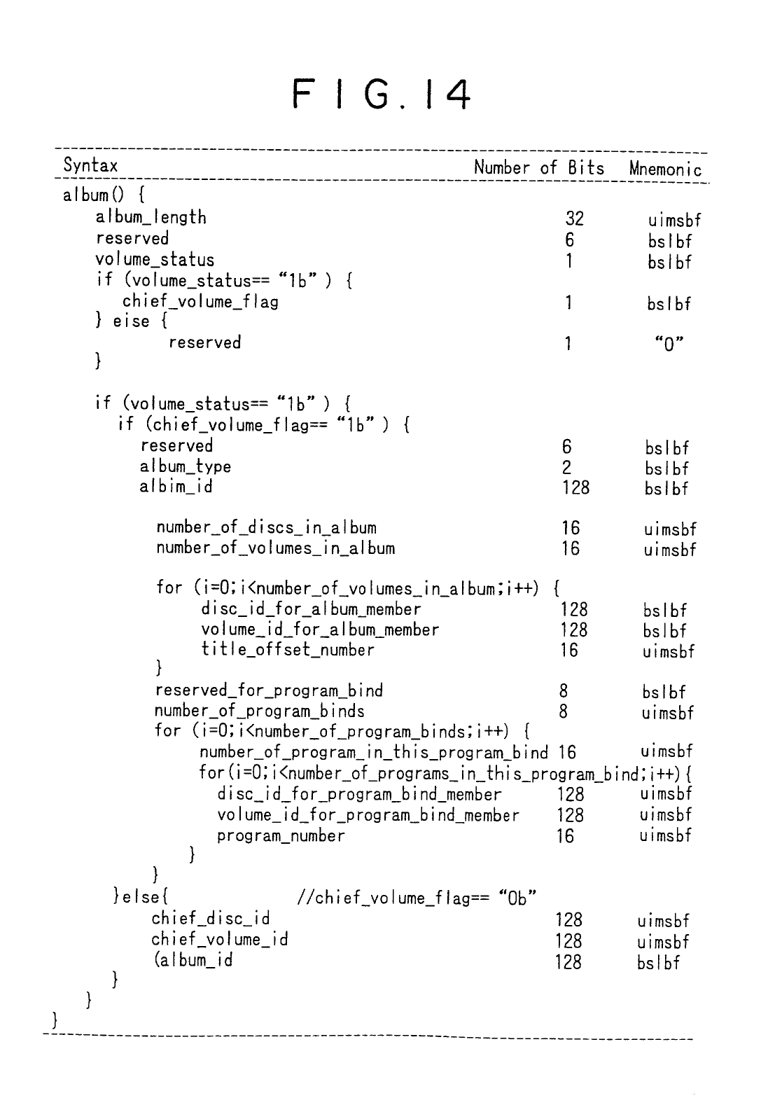

The file ALBUM.STR has a structure shown in FIG. 13. The leading area “file_type_id” is placed first to indicate the relevant file is ALBUM.STR. Next, the area “album( )” appears and is completed by the final area “text_block( ) ”.

The area “album( )” is used to record the information to deal with a plurality of volumes (a plurality of media) as one aggregation. Detail structure of this area is shown in FIG. 14.

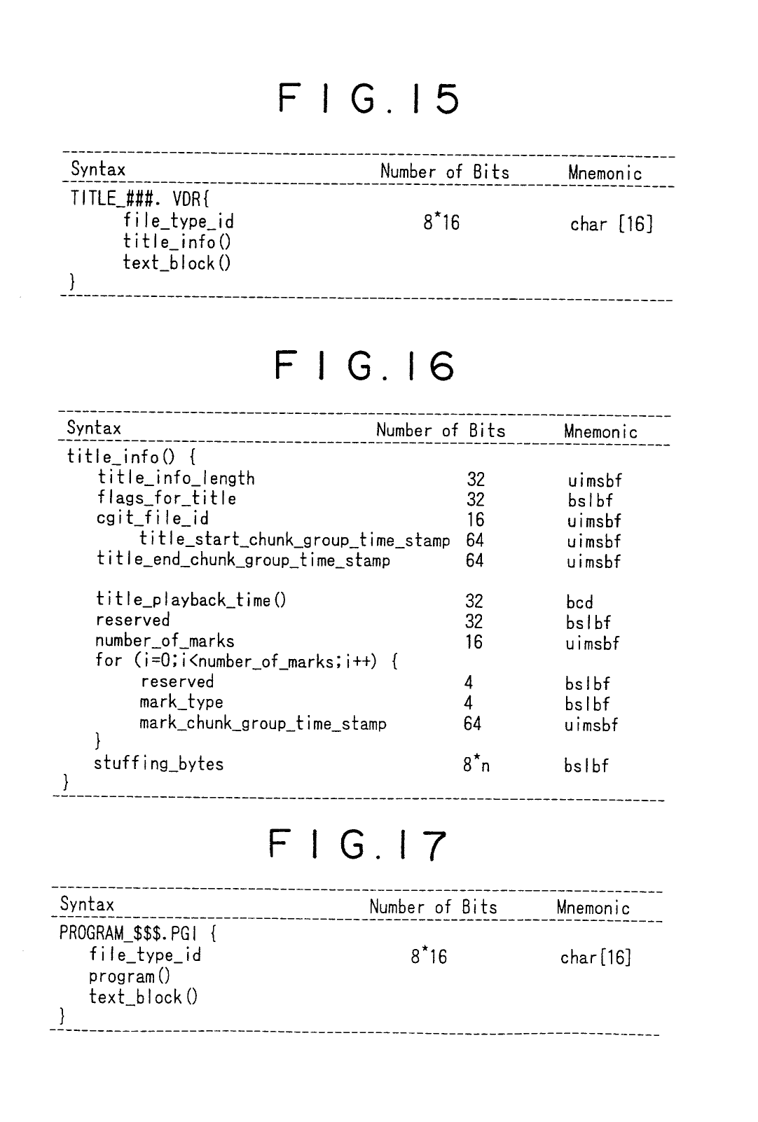

The file “TITLE_###.VDR” exists as many as the number of titles. Title means, for example, a title of a music recorded in a compact disk or a title of one program in the television broadcast. This information has the structure as shown in FIG. 15. The leading area “file_type_id” is placed first to indicates the relevant file is “TITLE_###.VDR”. Next, the second area “title info( )” appears and is followed by the area “text_block( )” as the final area. ### is a character string indicating the title number.

The area “title_info( )” is used for recording starting point, ending point of title and attribute of title on the chunkgroup. Detail structure of this area is shown in FIG. 16.

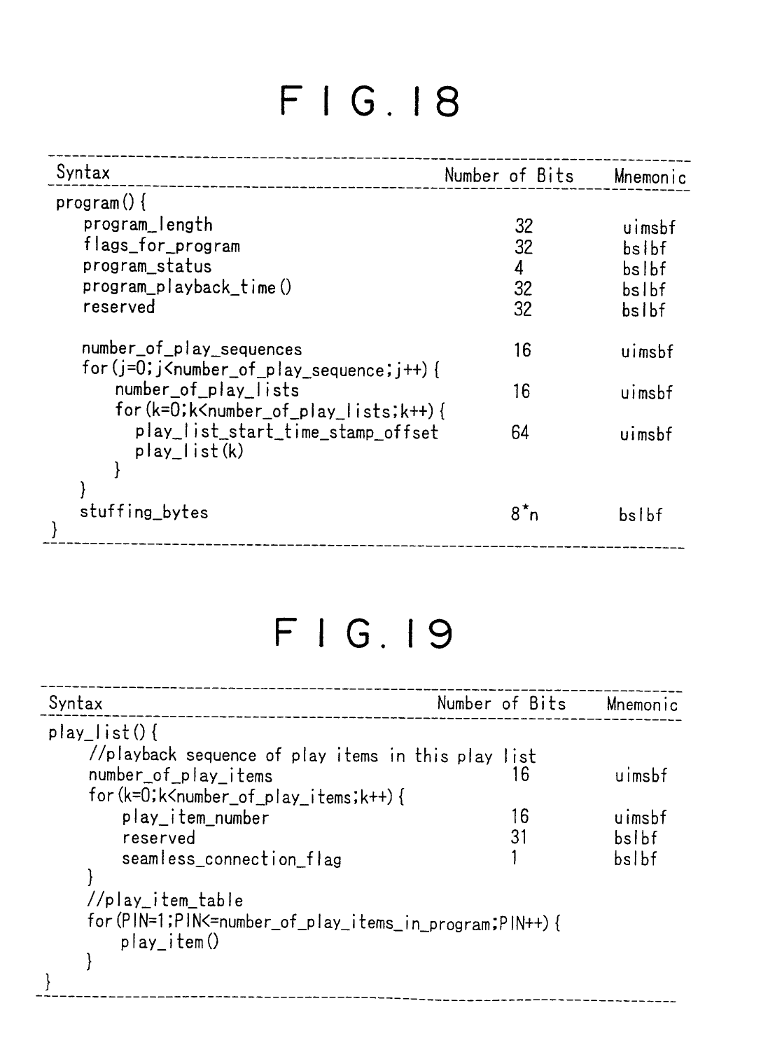

The “PROGRAM_$$$.PGI” file of FIG. 1 exists as many as the number of titles. A program is formed of a plurality of cuts designating a part (or entire part) of the area of title and each cut is reproduced in the designated sequence. Structure of this information is shown in FIG. 17. The area “file_type_id” is placed as the leading area to indicate the relevant file is “PROGRAM_$$$.PGI”. Next, the area “program( )” is appearing and followed by the area “text_block( )” as the final area. $$$ is a character string indicating the title number.

The area “program( )” is used for recording the information required to collect and reproduce the necessary portions of the title without non-reversible edition to a raw material. Detail structure of this area is shown in FIG. 18.

The area “program( )” of FIG. 18 has one “play_list” area. Detail structure of this “play list( )” area is shown in FIG. 19.

The area “play_list” includes a plurality of “play_item( )” areas. Detail structure of the “play_item( )” area is shown in FIG. 20.

The file “CHUNKGROUP_@@@.CGIT” of FIG. 1 exists as many as the number of chunkgroups. The chunkgroup is a data structure for arrangement of bit stream. This file is not recognized by a user while a user generally operates the apparatus for recording or reproducing a medium such as VDR (video disk recorder).

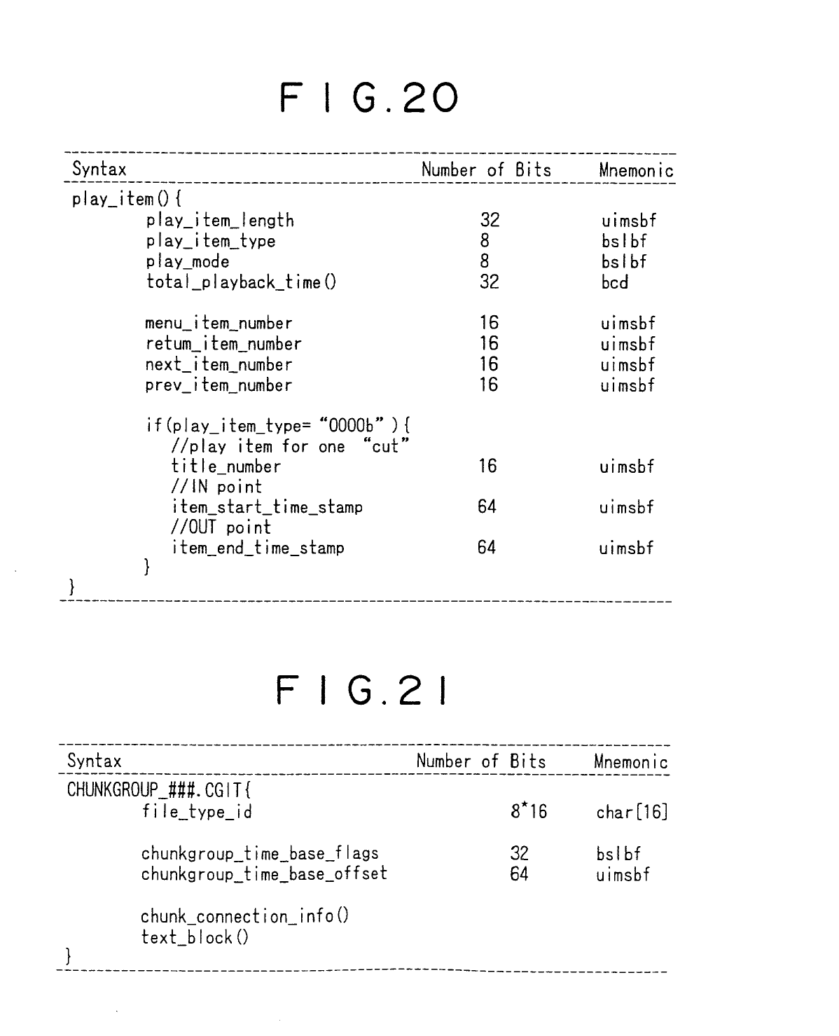

Structure of this information is shown in FIG. 21. The area “file_type_id” is placed as the leading area to indicate that the relevant file is “CHUNKGROUP_@@@.CGIT”. Next, the areas “chunkgroup_time_base_flags” and “chunkgroup_time_offset” appear, followed by the area “chunk_connection_info( )” and the area “text_block( )” as the final area.

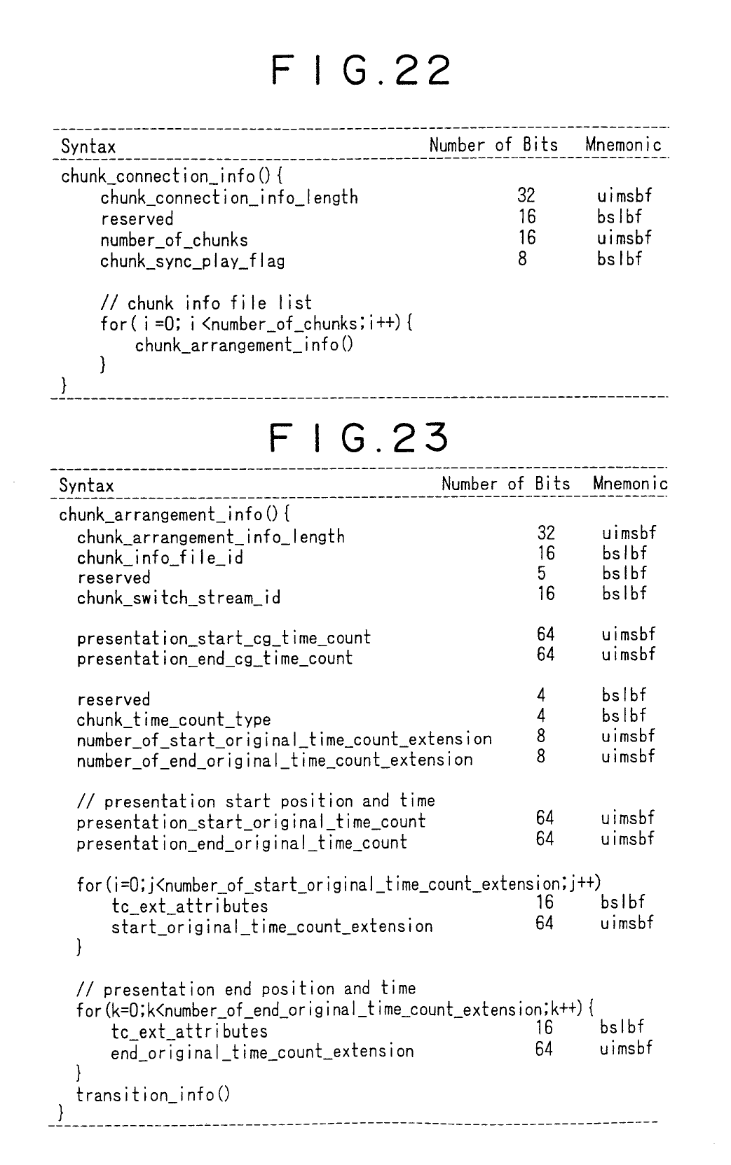

The area “chunkgroup_time_flags” indicates a flag in regard to the standard counter of chunkgroup, while the area “chunkgroup_time_base_offset” indicates a start time of the standard time axis. This value is set to a counter which counts up in every 90 kHz and has a size of 32 bits. The area “chunk_connection_info( )” is used for recording the information of the peculiar point such as the switching point of video and synchronization of video and audio signals. Detail structure of this area is shown in FIG. 22.

In this “chunk_connection_info( )” area, the loop of the “chunk_arrangement_info( )” is placed as many as the number of chunks belonging to the chunk group. Detail structure of this “chunk_arrangement_info( )” is shown in FIG. 23.

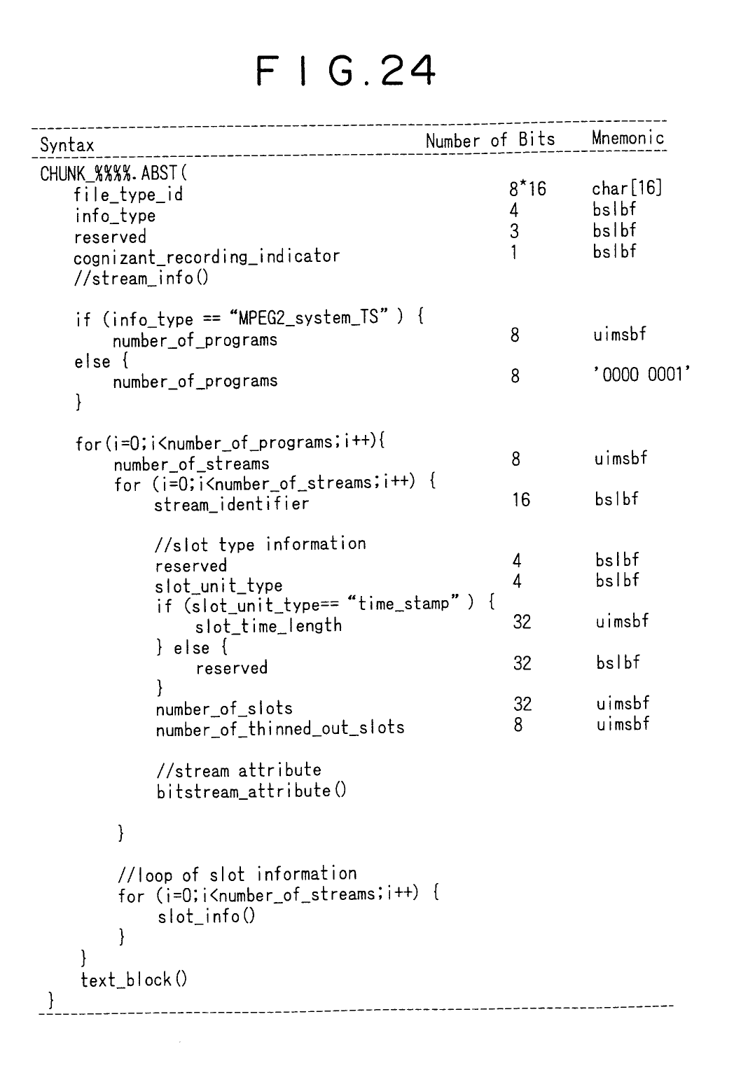

The file “CHUNK_%%%%.ABST” of FIG. 1 exists as many as the number of chunks. Chunk is an information file corresponding to one stream file. Structure of this information is shown in FIG. 24. The leading area “file_type_id” is placed first to indicate that the relevant file is “CHUNK_%%%%.ABST”.

The “CHUNK_%%%%.MPEG2” of FIG. 1 is a stream file. This file stores the bit stream of MPEG, unlike the other files which are recording the information only.

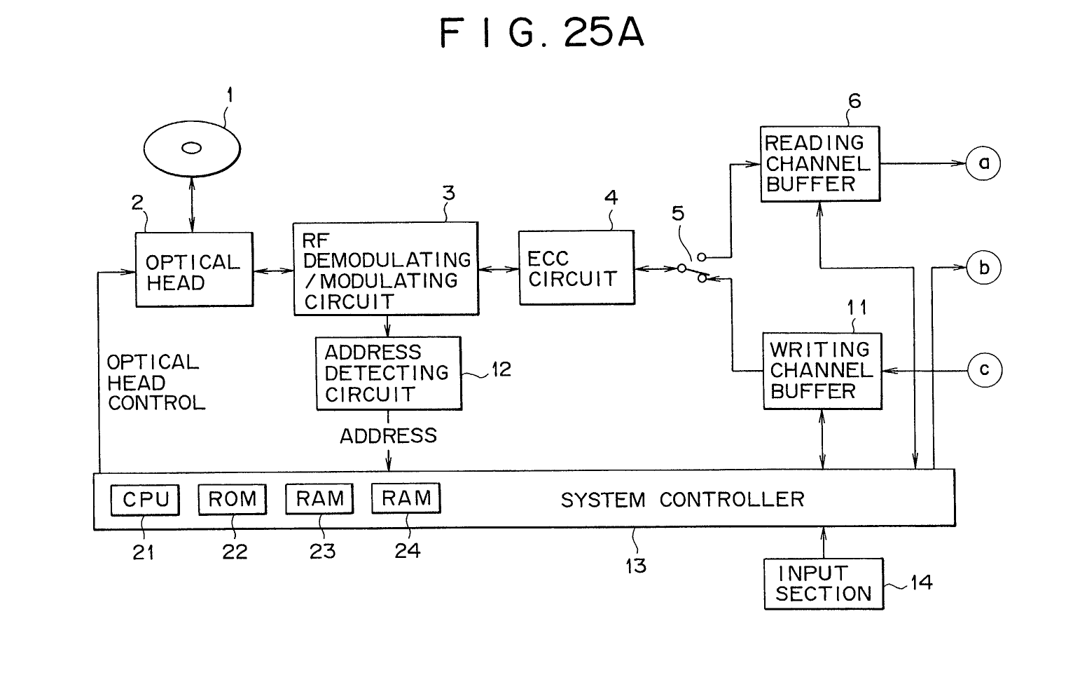

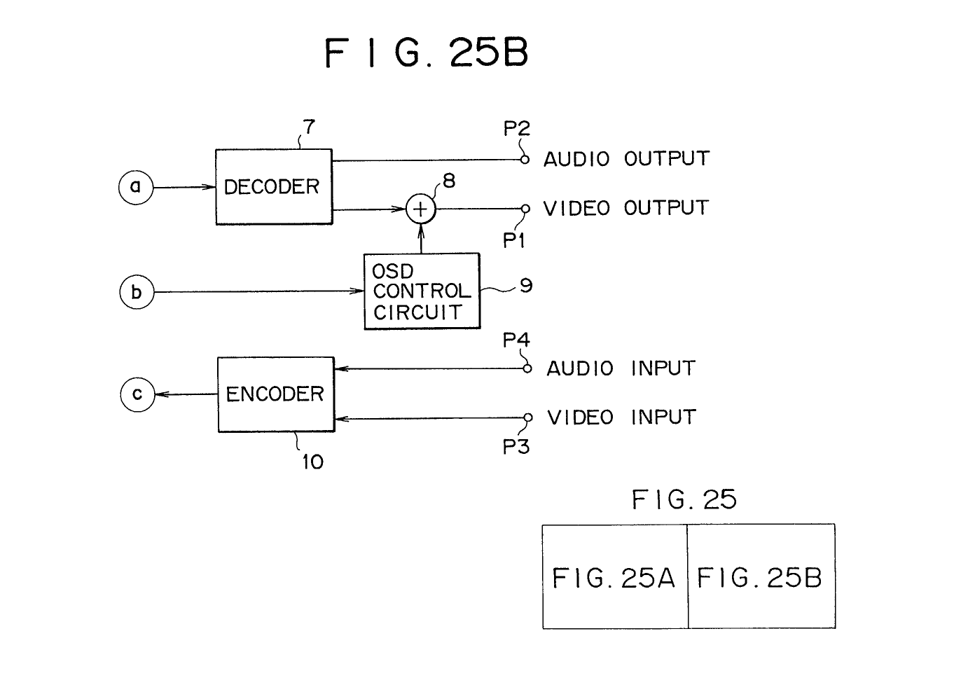

FIG. 25 shows an example of structure of an optical disk apparatus for recording or reproducing information to or from an optical disk as a medium having the files explained above. In this optical disk apparatus, an optical head 2 of one system is provided for a sheet of the programmable optical disk 1 the optical head 2 can be used for both data read and write operations.

A bit stream read from an optical disk 1 by an optical head 2 is demodulated by an RF and demodulating/modulating circuit 3 and is subjected to error correction by an ECC circuit 4. The signal is then sent to a read channel buffer 6 to absorb difference between the reading rate and decoding rate via a switch 5. An output of the reading channel buffer 6 is supplied to a decoder 7. The reading channel buffer 6 is structured to read and write the data from and to a system controller 13.

A bit stream output from the reading channel buffer 6 is decoded by a decoder 7 and a video signal and an audio signal are then output from the decoder 7. The video signal output from the decoder 7 is input to a composite circuit 8 and it is then combined with the video signal output from an OSD (On Screen Display) control circuit 9. Thereafter, the combined signal is then output to a display unit (not illustrated) from an output terminal P1 and is displayed thereon. An audio signal output from the decoder 7 is sent to a speaker not illustrated from the output terminal P2 and is then reproduced.

On the other hand, the video signal input from the input terminal 3 and the audio signal input from the input terminal P4 are encoded by an encoder 10 and are then sent to the writing channel buffer 11 to absorb difference between the encoding rate and writing rate. This writing channel buffer 11 is also structured to read and write the data from and to the system controller 13.

Data stored in the writing channel buffer 11 is read from the writing channel buffer 11 and is then input to the ECC circuit 4 via the switch 5 for addition of an error correction code and thereafter the data having this error correction code is then modulated by the RF and demodulating/modulating circuit 3. The signal (RF signal) output from the RF and demodulating/modulating circuit 3 is written into an optical disk 1 with an optical head 2.

An address detecting circuit 12 detects an address information of the track for recording or reproduction of an optical disk 1. A system controller 13 controls operation of each part of the optical disk apparatus and comprises ROM 22 for storing the processing programs to be executed by CPU21, CPU 21 which executes various controls, RAM 23 for temporarily storing data generated in the processes and RAM 24 for storing various kinds of information files to be recorded to or reproduced from the optical disk 1. CPU21 executes fine adjustment of position of the optical head 2 based on the detection result of the address detecting circuit 12. CPU21 also controls the switching operation of the switch 5. An input section 14 formed of various kinds of switches and buttons is manipulated by a user when various commands are input.

Next, the read operation of the basic information file will be explained. For example, when “VOLUME.TOC” information file is to be read, CPU21 of the system controller 13 defines, using a file system manipulation instruction previously built in the processing program, a physical address on the optical disk 1 where the “VOLUME.TOC” file is recorded and the length of the file. Subsequently, CPU21 shifts, based on the address information of the “VOLUME.TOC” file, the optical head 2 to the read position. CPU21 sets the optical head 2, RF and demodulating/modulating circuit 3 and ECC circuit 4 to the read mode, switches the switch 5 to the side of the reading channel buffer 6 and then executes fine adjustment of the position of optical head 2 and then starts the read operation by the optical head 2. Thereby, contents of the file “VOLUME.TOC” are read by the optical head 2 and is then demodulated by the RF and demodulating/modulating circuit 3. Moreover, after the error correction by the ECC circuit 4, such contents are accumulated in the reading channel buffer 6.

When amount of data accumulated in the reading channel buffer 6 becomes equal to or larger than the size of “VOLUME.TOC” file, CPU21 stops the read operation. Thereafter CPU21 reads the relevant data from the reading channel buffer 6 and stores the data to RAM24.

Next, the basic information file writing operation will be explained depending on the example of writing the “VOLUME.TOC” information file. CPU21 uses a file system manipulation instruction previously built in the processing program to search the file system (optical disk 1) to find a vacant area having the capacity equal to or larger than the “VOLUME.TOC” to be written now and defines the address of such area.

Next, CPU21 transfers the “VOLUME.TOC” prepared in RAM 24 for the new writing operation to the writing channel buffer 11. Subsequently, CPU21 moves the optical head 2 to the writing position based on the address information of the vacant area. CPU21 sets the optical head 2, RF and demodulating/modulating circuit 3 and ECC circuit 4 to the write mode and switches the switch 5 to the side of writing channel buffer 11 for the fine adjustment of the position of optical head 2. Thereafter, CPU21 starts the writing operation by the optical head 2.

Thereby, contents of the newly prepared “VOLUME.TOC” are read from the writing channel buffer 11 and are then input to the ECC circuit 4 via the switch 5. After the error correction code is added to the data in the ECC circuit 4, the data is modulated by the RF and demodulating/modulating circuit 3. The signal output from this RF and demodulating/modulating circuit 3 is recorded to the optical disk 1 by the optical head 2. When the data is read from the writing channel buffer 11 and amount of data recorded to the optical disk 1 becomes equal to the size of the “VOLUME.TOC”, CPU21 stops the write operation.

Finally, CPU21 rewrites the pointer indicating the “VOLUME.TOC” in the file system (optical disk 1) to indicate the new writing position, using the file system manipulating instruction previously built in the processing program.

Next, the basic stream reproducing operation will be explained considering, as an example, the reproduction of stream of CHUNK_0001.MPEG2 of FIG. 1. CPU21 defines a physical address of “CHUNK_000l.MPEG” recorded on the optical disk 1 and the length of this file, using the file system manipulating instruction previously built in the processing program. Subsequently, CPU21 moves the optical head 2 to the read position based on the address information of “CHUNK_0001.MPEG2”. CPU21 also sets the optical head 2, RF and demodulating/modulating circuit 3 and ECC circuit 4 to the reading mode and also switches the switch 5 to the side of the reading channel buffer 6. After fine adjustment of the optical head 2, CPU21 starts the read operation by the optical head 2.

Contents of the “CHUNK_0001.MPEG2” read by the optical head 2 are accumulated in the reading channel buffer 6 via the RF and demodulating/modulating circuit 3, ECC circuit 4 and switch 5. The data stored in the reading channel buffer 6 is then output to the decoder 7 for the decoding process. Thereby, both video signal and audio signal can be output from the decoder 7. The audio signal is output from the output terminal P2, while the video signal from the output terminal P1 via a combining circuit 8.

When amount of data read from the optical disk 1, decoded and then displayed becomes equal to the size of the “CHUNK_0001.MPEG2” or when stop of read operation is designated from the input section 14, CPU21 stops the reading and decoding processes.

Next, the basic stream recording operation will be explained considering the writing of the “CHUNK_000l.MPEG2” as an example. CPU21 searches the file system (optical disk 1) to know whether there is a vacant area having the same or larger size as the “CHUNK_0001.MPEG2” or not using the file system manipulation instruction previously built in the processing program and then defines the address of such vacant area.

The video signal input from the input terminal P3 and the audio signal input from the input terminal P4 are encoded by he encoder 10 and are then accumulated in the writing channel buffer 11. Subsequently, CPU21 moves the optical head 2 to the write position based on the address information of vacant area. CPU21 sets the optical head 2, RF and demodulating/modulating circuit 3 and ECC circuit 4 to the write mode and also switches the switch 5 to the side of writing channel buffer 11 to conduct the fine adjustment of the optical head 2 and then starts the write operation by the optical head 2. Thereby, contents of newly prepared “CHUNK_0001.MPEG2” are read from the writing channel buffer 11 and are then input to the optical head 2 and recorded to the optical disk 1 via the switch 5, ECC circuit 4 and RF and demodulating/modulating circuit 3.

When amount of data which is read from the writing channel buffer 11 and is then recorded to the optical disk 1 becomes equal to the preset value or stop of write operation is designated from the input section 14, CPU21 stops the write operation. Finally, CPU21 rewrites the pointer indicating “CHUNK_0001.MPEG2” in the file system (optical disk 1) to indicate the newly written position, using the file system manipulation instruction previously built in the processing program.

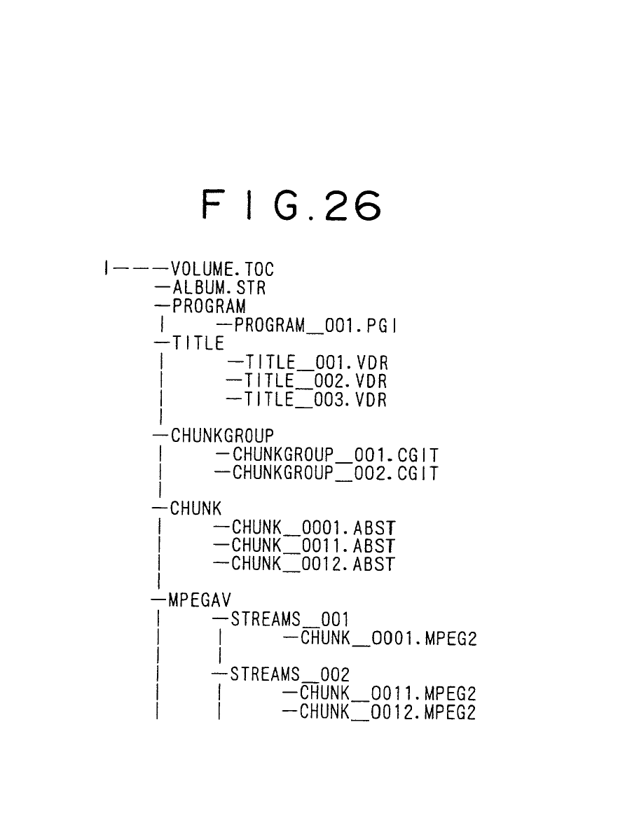

Here, it is assumed that the information file and stream file shown in FIG. 26 are recorded in the optical disk 1. In this example, one program file having the name “PROGRAM_001.PGI” is included. Moreover, this optical disk 1 includes the three files having the titles “TITLE_001.VDR”, “TITLE_002.VDR”, “TITLE_003.VDR”.

Moreover, this optical disk 1 also the files of two chunk groups of “CHUNKGROUP_001.CGIT” and “CHUNKGROUP_002.CGIT”. In addition, this optical disk 1 includes the files of three streams having the names “CHUNK_0001.MPEG2”, “CHUNK_0011.MPEG2”, “CHUNK_0012.MPEG2” and has three information files of “CHUNK_0001.ABST”, “CHUNK_0011.ABST” and “CHUNK_0012.ABST” as the information corresponding above files.

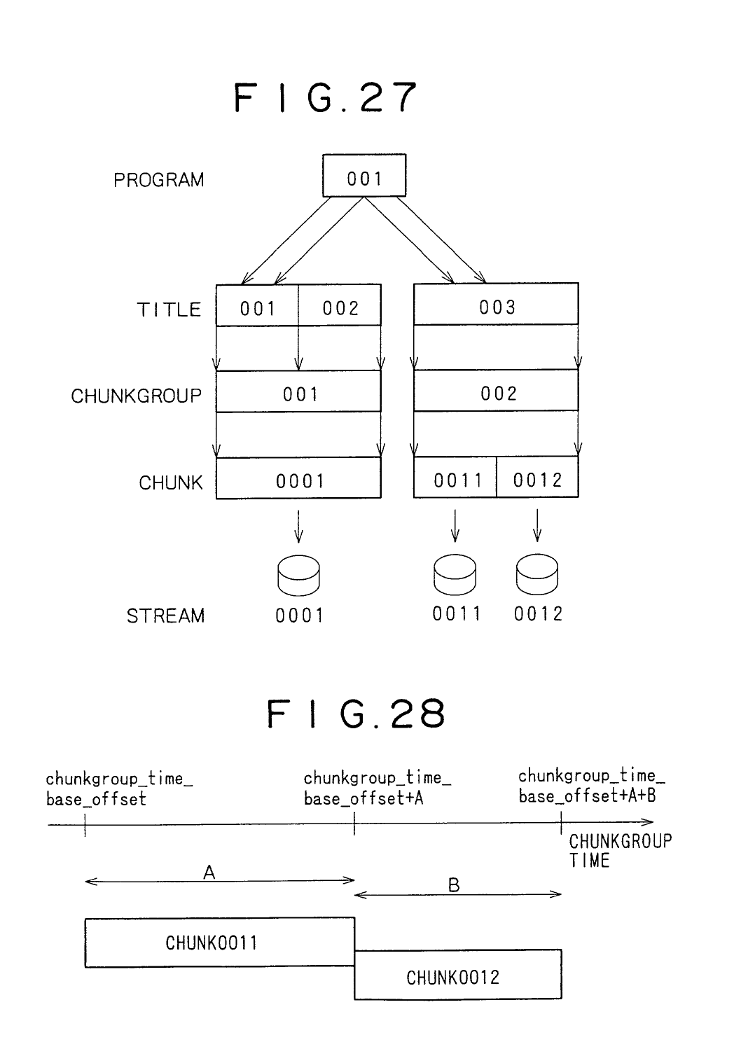

FIG. 27 shows the logical structure of the optical disk 1 having the information file and stream file shown in FIG. 26. In this example, the chunk information file “CHUNK_0001.ABST” designates the stream file “CHUNK_0001.MPEG2”, while the chunk information file “CHUNK_0011.ABST” designates the stream file “CHUNK_0011.MPEG2” and the chunk information file “CHUNK_0012.ABST” designates the stream file “CHUNK_0012.MPEG2”, respectively. In more practical, the field “chunk_file_id” in the “CHUNK_%%%%.ABST” designates the file ID of stream.

Moreover, in this example, chunk group information file “CHUNKGROUP_001.CGIT” designates the chunk information file “CHUNK_0001.ABST”, while the chunk group information file “CHUNKGROUP_002.CGIT” designates the chunk information files “CHUNK_0011.ABST” and “CHUNK_0012.ABST”, respectively. In more practical, the field “chunk_info_file_id” in “chunk_arrangement_info( )” of FIG. 23 designates the file ID of the chunk information. This chunk_arrangement_info( ) has the data structure to be provided in the chunk group information file and to exist as many as the number of chunks belonging to the relevant chunk group (chunk_arrangement_info( ) of FIG. 23 is described in chunk_connection_info( ) of FIG. 22 and this chunk_connection_info( ) is described in CHUNKGROUP_###.CGIT of FIG. 21).

CHUNKGROUP_001 includes only one chunk₁₃arrangement_info( ) and chunk_info_file_id in above field designates CHUNK_0001. CHUNKGROUP_002 includes two chunk_arrangement_info( ) fields to designates the CHUNK_0011 and CHUNK_0012. Considering the case explained above, the chunk group can designate the reproduction sequence of a plurality of chunks.

In more practical, first chunkgroup_time_base_offset in CHUNKGROUP_###.CGIT of FIG. 21 defines the initial value of a clock in the relevant chunk group. Next, on the occasion of registering each chunk, presentation_start_cg_count and presentation_end_cg_time_count of chunk_arrangement_info( ) of FIG. 23 are designated.

For example, as shown in FIG. 28, length (time) of CHUNK_0011 is defined as A, while length (time) of CHUNK_0012 is defined as B. The field presentation_start_cg_count of CHUNK_0011 is equal to chunkgroup_time_base_offset, while the field presentation_end_cg_count is equal to chunk_group_time_base_offset+A. Moreover, the field presentation_start_cg_count of CHUNK_0012 is equal to chunkgroup_time_base_offset+A and presentation_end_cg_count is equal to chunk_group_time_base_offset +A +B. When above setting is conducted, CHUNKGROUP_002 is defined as the result of continuous reproduction of CHUNK_0011 and CHUNK_0012.

When the reproducing times of CHUNK_0011 and CHUNK_0012 overlap, the fields maybe designated by shifting the time. Moreover, the special effect (fade in, fade out, wipe, etc.) can be designated in the transition between a couple of streams by making description to the field transition_info( ) in the chunk_arrangement_info( ) of FIG. 23.

In the example of FIG. 26(FIG. 27), the title information files “TITLE_001.VDR”, “TITLE_002.VDR” designate the chunk group information file “CHUNKGROUP_001.CGIT” and the title information files “TITLE_003.VDR” designates the chunk group information file “CHUNKGROUP_002.CGIT”, respectively. In more practical, the field cgit_file_id in the title_info( ) of FIG. 16 designates the file ID of chunk group and moreover the fields title_start_chunk_group_time_stamp and title_end_chunk_group_time_stamp designate the range of time for defining the relevant title in the chunk group.

For example, the TITLE_001 designates the former half of CHUNKGROUP_001, while TITLE_002 the latter half thereof respectively in an example of FIG. 27. This division is executed depending on the request from user. The dividing position is set freely by user and such position cannot be determined previously. Here, it is assumed that the dividing position by TITLE_001 and TITLE_002 is set to the position isolated by A from the leading field of CHUNKGROUP_001.

TITLE_001 designates CHUNKGROUP_001 as the chunk group, the starting time of CHUNKGROUP_001 is designated as the starting time of title and the time of the point designated by user is designated as the end time of the title.

Namely, chunkgroup_time_base_offset(leading position) of CHUNKGROUP_001 is set as title_start_chunk_group_time_stamp of TITLE_0011 and the result obtained by adding the size of A to chunkgroup_time_base_offset of CHUNKGROUP_001 is set as title_end_chunk_group_time_stamp of TITLE_001.

Moreover, TITLE_002 designates CHUNKGROUP_001 as the chunk group, the time of the point designated by user is designated as the start time of title and the end time of CHUNKGROUP_001 is designated as the end time of title.

Namely, as the title_start_chunk_group_time_stamp of TITLE_002, the result obtained by adding the size of A to chunkgroup_time_base_offset(leading position) of CHUNKGROUP_001 is designated and as title_end_chunk_group_time_stamp of TITLE_002, the result obtained by adding the size of CHUNKGROP_001 to chungroup_time_base_offset of CHUNKGROUP_001 is set.

Moreover, TITLE_003 designates CHUNKGROUP_002 as the chunk group, and the start time of CHUNKGROUP_002 as the start time of title and also the end time of CHUNKGROUP_002 as the end time of title.

Namely, chunkgroup time_base_offset of CHUNKGROUP_002 is set as title_start_chunk_group_time_stamp of TITLE_003 and the result obtained by adding the size of CHUNKGROUP_002 to chunkgroup_time_base_offset of CHUNKGROUP_002 is set as title_end_chunk_group_time_stamp of TITLE_003.

Moreover, in this example, the program information file “PROGRAM_001.PGI” designates a part of TITLE_001 and a part of TITLE_003 to be reproduced in this sequence. In more practical, one cut can be extracted by designating the title with title_number in play_item( ) of FIG. 20 and then defining the start and end points with the times defined by each title. A program can be formed by collecting a plurality of such cuts.

Next, operation of additionally recording a new information (append recording) to an optical disk 1 will be explained. In practical, this recording is conducted, for example, by the timer recording or by issuing, on the real time basis, the recording to the optical disk apparatus by manipulation of the input section 14 by a user. In the latter case, when a recording button is depressed, the recording end time cannot be forecasted, but when the single-action recording function (recording is conducted for a constant period after manipulation) button is depressed, the recording end time can be forecasted.

Here, the timer recording will be explained as an example. In this case, it is assumed that a user of the optical disk apparatus has previously designated the recording start time, recording end time, bit rate of bit stream and recording channel. Moreover, it is also checked previously that when the recording is reserved, the vacant capacity sufficient for bit rate and recording time is yet left in the optical disk 1.

If different recording is conducted to the optical disk 1 when the recording is reserved and when the reserved recording is executed, it becomes impossible in some cases to acquire the capacity for recording the program reserved this time with the designated bit rate. In this case, CPU21 lowers the bit rate than the designated value to record the information for the reserved recording period or executes the recording for the available period by keeping the bit rate as it is. In this case, CPU 21 issues, as a matter of course, a message to a user when the recording is further conducted and a certain problem is generated in the reserved recording operation.

When the start time of the reserved recording is coming closely, CPU21 uses a built-in timer and a clock to automatically return the sleep mode to the operation mode. CPU21 acquires the area to record the reserved program on the optical disk 1, using the file system manipulating instruction previously built in the processing program. Namely, a value obtained by multiplying a bit rate to the result (recording time) obtained by subtracting the start time from the end time of reserved recording is a size of the area required for recording the reserved program. CPU 21 acquires first the area having this size. Moreover, when it is required to record the information file in addition to the stream file on the occasion of such recording, for example, when the title information file is required for registration as the new title, the capacity to record such information file must also be acquired in the optical disk 1. When the necessary area cannot be acquired, an adequate measure is taken depending on the method explained above (change of bit rate, recording within the possible period).

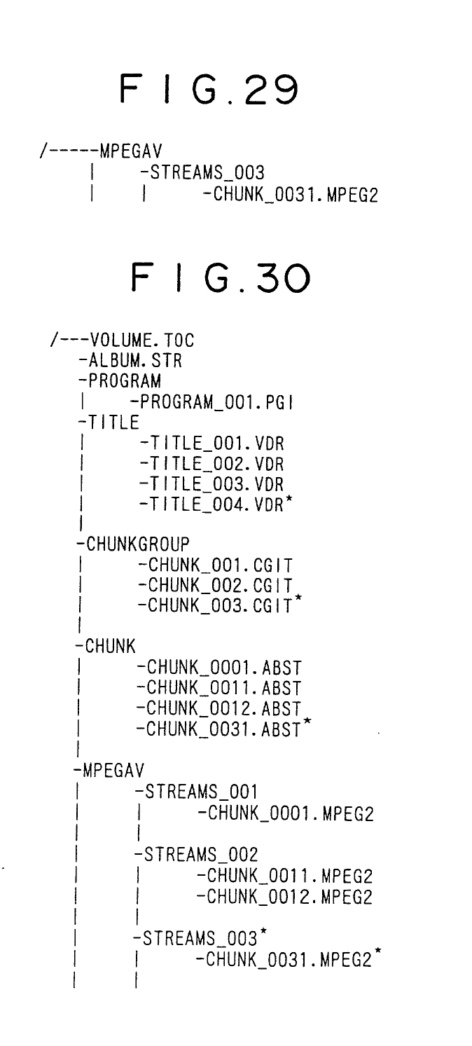

In this case, since a new title is recorded, a user is requested to give a file name of the new stream file as the new stream file of the new stream directory. Here, it is assumed as ¥MPEGAV¥STREAMS_003¥CHUNK_0031. Namely, as shown in FIG. 29, the file is considered as that having the name of CHUNK_0031.MPEG2, under the STREAM_003 directory under the MPEGAV directory under the root directory.

CPU21 instructs execution of recording mode to each section. For example, the video signal input to the input terminal P3 from a tuner not illustrated and the audio signal input to the input terminal P4 are encoded by the encoder 10 and are then accumulated in the writing channel buffer 11. Subsequently, CPU21 moves the optical head 2 to the write position based on the address information of the area acquired previously. CPU21 sets the optical head 2, RF and demodulating/modulating circuit 3 and ECC circuit 4 to the write mode and switches the switch 5 to the writing channel buffer 11 side. After the fine adjustment of position of the optical head 2, CPU21 starts the writing operation by the optical head 2. Thereby, contents of the newly prepared CHUNK_0031.MPEG2are read from the writing channel buffer 11 and are then recorded to the optical disk 1 via the switch 5, ECC circuit 4, RF and demodulating/modulating circuit 3 and optical head 2.

When above write operation is continued and any one of the following conditions is generated, CPU21 stops the write operation.

1) when the reserved recording end time is matured;

2) when recording to the optical disk 1 becomes impossible due to insufficient recording capacity or the other causes;

3) when instruction to stop the recording operation is issued.

Next, CPU21 updates the pointer indicating CHUNK_0031.MPEG2in the file system to indicate the newly written position, using the file system manipulation instruction previously built in the processing program. Moreover, CPU21 prepares the chunk information, chunkgroup information and title information and records these data by giving the name respectively. In this case, it is necessary to acquire the vacant capacity to record these files on the optical disk 1 at the time of recording or reservation.

As explained above, a new file is generated, for example, as shown in FIG. 30. In this figure, the file name which is given the asterisk mark (*) at the upper right area has been newly generated.

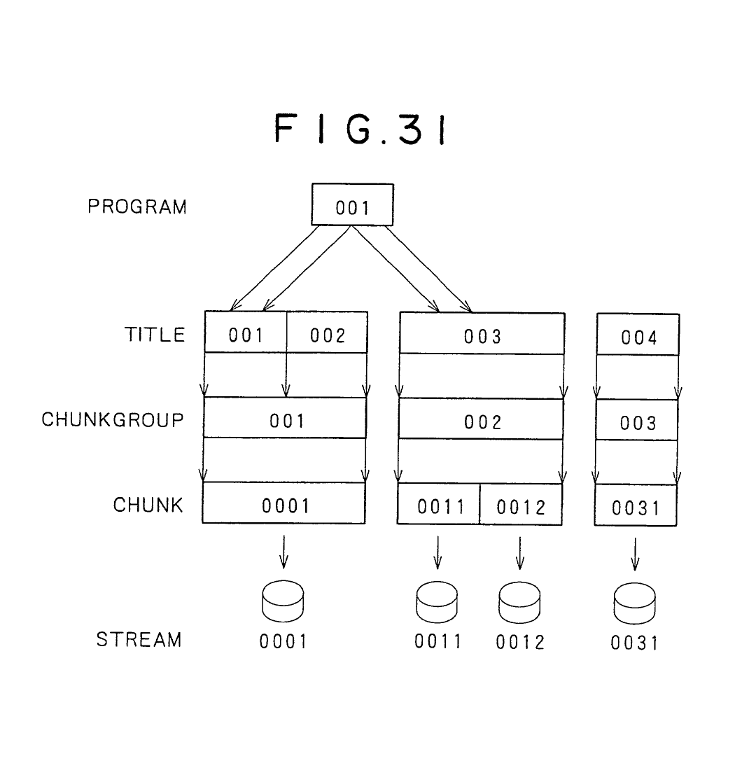

FIG. 31 shows relationship among the newly generated information files. TITLE_004 designates CHUNKGROUP_003, while CHUNKGROUP_003 designates CHUNK_0031 and CHUNK_0031 designates STREAM_0031.

Namely, a new stream is registered to the information file as TITLE_004. A user can detect attribute of TITLE_004 with the function to recognize the title of the optical disk apparatus. Moreover, TITLE_004 can be reproduced.

Next, operation for over-writing the recording data on the optical disk 1 as is shown in FIG. 26 (FIG. 27) will then be explained. The over-write recording means that a new program is recorded over the program being recorded (by erasing the recorded program) as in the case of the recording the signal on a video tape.

In the over-write recording, it is important to define the position to start the over-write recording. For example, it is assumed that a user has designated to start the over-write recording from the leading area of TITLE_001. In this case, the over-write recording is conducted by sequentially updating TITLE_001, TITLE_002 and TITLE_003. When the recording operation is not yet completed even after TITLE_003 is updated completely, recording is continued by acquiring a new area in the vacant area on the optical disk 1. For example, when TITLE_002 has been defined as the recording start position, TITLE_001 is never updated by this recording operation because it is located preceding the recording start position.

Here, it is assumed that the over-writing is conducted by the timer recording mode from the leading area of TITLE_003. In this case, it is also assumed that a user of the optical disk apparatus has designated the recording start time, end time, bit rate of bit stream and recording channel, etc. Moreover, it is also assumed that the recording start time which is important for the over-write recording is designated at the leading area of TITLE_003. Moreover, it is previously recognized, in this case, that the capacity sufficient for the bit rate and recording time is existing on the optical disk 1 when the recording is reserved. In the case of the over-write recording, total recording capacity can be obtained by adding the capacity of the over-writing (a plurality of) titles from the designated position and the vacant capacity of the optical disk 1. Namely, in the case of this operation, the recording capacity can be obtained as a result of addition of the total capacity of STREAM_0011 and STREAM_0012 managed by TITLE_003 and the vacant capacity on the optical disk 1.

In the over-write recording, there are some ways for selection in which sequence the recording should actually be done for the recording capacity. In the first method, recording is executed in the sequence of the stream designated by the title. Namely, in the case of this operation, recording is started from the leading area of STREAM_0011. When recording is made up to the final area of STREM_0011, recording is continued from the leading area of STREAM_0012. When recording is completed up to the final area of STREAM_0012, recording is then made to the vacant area. In the next method, recording is conducted first to the vacant area and when recording is completed to the vacant area, recording is executed to the existing streams.

The former method is preferential in such a sense as emulation of video tape. Namely, the former method is characterized in that it can be easily understood by user in such a sense of the operation similar to the video tape. The latter method is characterized in such a point that the recorded contents are protected because erasing of the already recorded streams is executed later.

When recording is further conducted to the optical disk 1 during the period between the reservation of recording and actual execution of reserved recording, the capacity to record the program reserved this time in the designated bit rate cannot be acquired in some cases. In this case, as explained previously, the bit rate is automatically lowered at the time of reservation to perfectly conduct the recording for the reserved period or the bit rate is kept unchanged and recording is conducted only for possible time.

When the start time of the reserved recording is coming up closely, the optical disk apparatus is returned to the operation mode from the sleep mode. CPU21 acquires all vacant areas on the optical disk 1. Of course, it is also considered that the vacant capacity is not acquired in this timing but it is acquired when it is required. Here, for the purpose of explanation, the necessary area is assumed to be acquired before the recording is started.

When the size of necessary area is previously known because start time, end time and bit rate are designated by the timer recording mode, only the necessary capacity (or the capacity as large as adding a certain margin) can also be acquired. When recording of the information file is required at the time of recording operation, for example, when the title information file is required for registration as the new title, the capacity to record such information files must be left unused.

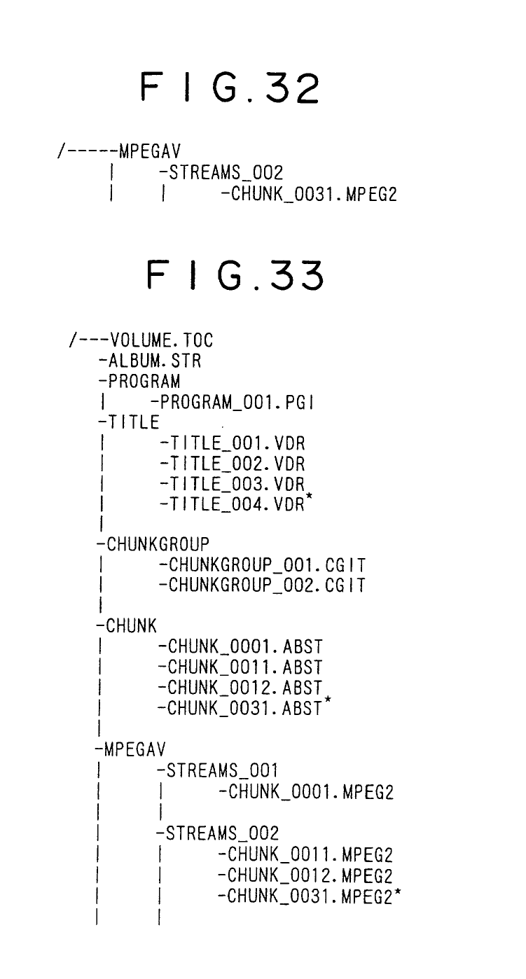

Here, it is assumed that a file name is given to the new stream file as the new stream file of the new stream directory. Namely, here, the file name is defined as ¥MPEGAV¥STREAMS_002¥CHUNK_0031. Namely, as shown in FIG. 32, a file having the name CHUNK_0031.MPEG2under the directory STREAM_002 under the MPEGAV directory under the root directory is generated.

The video signal input to the input terminal P3 and audio signal input to the input terminal P4 are encoded by the encoder 10 and are then accumulated in the writing channel buffer 11. Subsequently, CPU21 moves the optical head 2 to the write position based on the address information of the area acquired previously. CPU21 sets the optical head 2, RF and demodulating/modulating circuit 3 and ECC circuit 4 to the write mode and switches the switch 5 to the writing channel buffer 11 side to start the write operation by the optical head 2 after fine adjustment of the position of the optical head 2. Thereby, contents of the newly prepared CHUNK_0031.MPEG2are read from the writing channel buffer 11 and are then recorded to the optical disk 1 via the switch 5, ECC circuit 4, RF and demodulating/modulating circuit 3 and optical head 2.

In this case, the stream file CHUNK_0011.MPEG2is updated first. When recording is conducted up to the final area of CHUNK_0011.MPEG2, recording is then continued for CHUNK_0012.MPEG2and then conducted for CHUNK_0031.MPEG2.

Above operation is continued and when any one of three conditions is generated as in the case explained above, CPU21 stops the write operation.

Next, CPU21 updates stream file, chunk information, chunkgroup information and title information, using the file system manipulation instruction previously built in the processing program.

Structure of file is changed depending on the timing for ending the write operation. For example, when recording is further conducted to CHUNK_0031.MPEG2after completing the over-writing of the streams of CHUNK_0011.MPEG2and CHUNK_0012.MPEG2, the file of the optical disk 1 has the structure shown in FIG. 33. The file which is newly generated is given the asterisk mark at the upper right area of the file name.

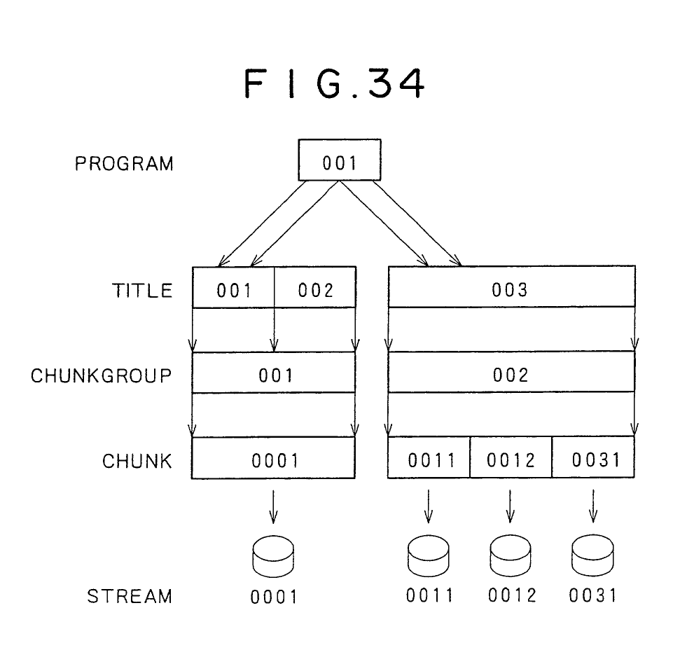

FIG. 34 shows relationship among the files newly generated (file of FIG. 33). As is apparent in comparison with FIG. 31, CHUNK_0031 is increasing as the CHUNK included in CHUNKGROUP_002 designated by TITLE_003 and CHUNK_0031 designates STREAM_0031.

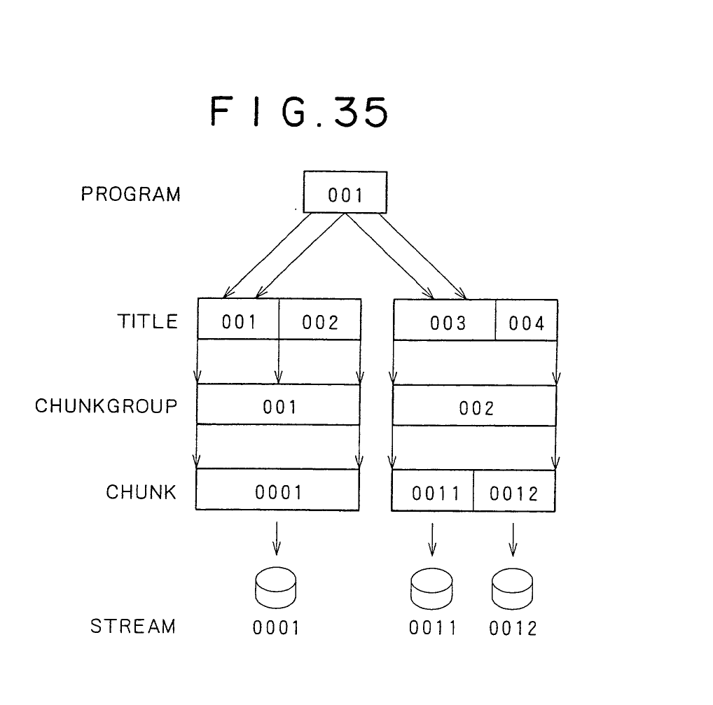

Meanwhile, when the over-write recording is completed in the course of the over-writing of existing stream, for example, when the over-write recording is completed in the course of CHUNK_0011, the stream of CHUNK_0031 acquired for over-writing is released because over-writing is not conducted. In this case, the special title is processed. Namely, when the over-write recording is started from the leading area of TITLE_003 and the recording is completed in the course of the recording operation, the title is divided in this timing. Namely, as shown in FIG. 35, the field between the over-write recording start position and end position is newly defined as TITLE_003 and subsequent field (the remaining field of original TITLE_003) is defined as TITLE_004.

Next, operation of reproducing the title will be explained. Here, it is assumed that the optical disk 1 having the file shown in FIG. 26 is inserted to the optical disk apparatus for the purpose of reproduction of title. When the optical disk 1 is loaded, CPU21 reads the information files from the optical disk 1 and stores these data to RAM4. This operation is conducted by repeating the basic information file reading operations explained above.

CPU21 reads first VOLUME.TOC and ALBUM.STR. Next, CPU21 searches how many files having the extension “.VDR” are existing in the field after the directory “TITLE”. The file having this extension also has the title information and the number of such files is equal to the number of titles. In the case of the example of FIG. 26, the number of titles is 3. Next, CPU21 reads the three title information files and then stores these files to RAM24.

CPU21 also controls an OSD control circuit 9 to generate character information indicating the title information recorded on the optical disk 1, mixes the character information with a video signal in the combining circuit 8, and outputs the signal to the display unit from the output terminal P1. In this case, three titles and sizes and attributes of three titles (names, date of recording) are displayed.

Here, it is assumed that a user has designated, for example, reproduction of TITLE_002. The information file of TITLE_002 (cgit_file_id in title_info( ) of FIG. 16) is recording the file ID for designating CHUNKGROUP_001 and CPU21 stores this file ID and also stores CHUNKGROUP_001 to RAM 24.

Next, CPU21 searches to which CHUNK the start time and end time of TITLE_002 (title_start_shunk_group_time_stamp and title_end_chunk_group_time_stamp of title_info( ) of FIG. 16) corresponds. This search is conducted by comparing the information (presentation_start_cg_time_count and presentaion_end_cg_time_count of chunk_arrangement_info( ) of FIG. 23) registering CHUNK from the information of CHUNKGROUP. In this case, as shown in FIG. 27, it can be understood that the start time of TITLE_002 is provided in the course of CHUNK_0001. Namely, it can be understood that TITLE_002 can be reproduced from the beginning by starting the reproduction in the course of the stream file CHUNK_0001.MPEG2.

Next, CPU21 searches where is the leading area of TITLE_002 in the stream. Namely, it is calculated where is the start time of TITLE_002 in the offset time of stream (time stamp) and the reproduction start point immediately before the start time is determined using the characteristic point information in the CHUNK file. Thereby, the offset distance of the reproduction start time from the leading area of file can be determined.

Next, CPU21 determines the physical address and size thereof on the optical disk 1 in which CHUNK_0001.MPEG2is recorded, using the file system manipulation instruction previously built in the processing program. Moreover, the offset address of reproduction start point obtained above is added to this address to finally determine the address of reproduction start point of TITLE_002.

Subsequently, CPU21 moves the optical head 2 to the read position based on the address information of this CHUNK_0001. MPEG2. CPU21 sets the optical head 2, RF and demodulating/ modulating circuit 3 and ECC circuit 4 to the read mode and switches the switch 5 to the reading channel buffer 6 side to start the read operation by the optical head 2 after fine adjustment of the position of optical head 2. Thereby, contents of CHUNK_0001.MPEG2are accumulated in the reading channel buffer 6.

The data stored in the reading channel buffer 6 is output to the decoder 7 for the decoding process and thereby the video signal and audio signal are output from the decoder 7. When the data read from the optical disk 1, decoded and displayed becomes equal to the size of CHUNK_0001.MPEG2, CPU21 shifts to the reproduction of TITLE_003. Reproducing operation of TITLE_003 is similar to the reproducing operation of TITLE_002.

When reproduction of registered titles is completed, or when stop of the read operation is instructed, the reading and decoding processes are stopped.

When a new disk or a disk of different format is loaded as the optical disk 1 to the optical disk apparatus, CPU21 tries to read VOLUME.TOC and ALBUM.STR, but such files do not exist in these disks. In this case, namely when VOLUME.TOC and ALBUM.STR cannot be read, CPU21 outputs a message to obtain an instruction from a user. A user issues an instruction to CPU21 to eject the optical disk 1 (for example, if a disk of different format is loaded), or to initialize the disk (for example, if a new disk of the same format is loaded) or to recover the data by a certain method (for example, when the disk of the same format is loaded but the data is destroyed).

Next, title will be explained. As shown in FIG. 15, the file TITLE_###.VDR is provided for storing the title information. Information of one title is recorded to one title_info( ). Only one title_info( ) exists in the file TITLE_###.VDR. Therefore, TITLE_##.VDR exists as many as the number of titles in the volume.

The title number is not defined in the title_info( ) of FIG. 16 but is determined by the file name or file id. Therefore, a positive integer ### in the TITLE_###.VDR indicates the title number. Title does not indicate a structure but a range given, to the chunkgroup, from the title index showing the start point to the title index showing the leading area of the next title or to the end point of chunkgroup.

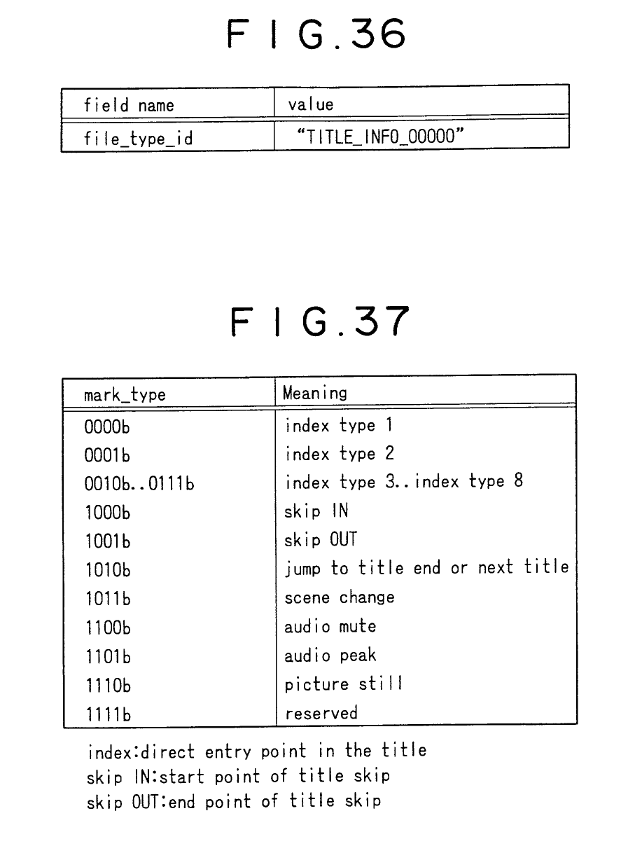

The field file_type_id of TITLE_###.VDR of FIG. 15 indicates the file in which title_info( ) is recorded as shown in FIG. 36 and expressed by the character string in the size 16. The field text_block( ) stores various texts and only the text item which is allowed to use text_block( ) is described.

The area title_info( ) is used, as shown in FIG. 16, for description of start point and end point of title and attribute of title on chukgroup. Moreover, the field title_info( ) is capable of having a flag to indicate whether the seamless reproduction can be assured or not between the titles. With this flag, whether seamless reproduction can be realized or not between the titles can be detected previously and whether rearrangement is necessary or not at the time of combining can also be known.

Since a boundary of titles becomes also a boundary of files, seamless reproduction is not assured in some cases. However, it is also generally possible to establish the L condition for the seamless reproduction by conducting re-arrangement, etc. as the function of the optical disk apparatus.

The field title_info_length in the title_info( ) of FIG. 16 indicates the length of title_info( ) in unit of the byte. In the field flags_for_title, the write attribute of the corresponding title, write (acknowledgment of change), limitation on the number of times of reproduction and rating level, etc. are described. In the field cgit_file_id, file_id of information file (CHUNKGROUP_###.CGIT) of chunkgroup which is the base of corresponding title is recorded.

In the field title_start_chunk_grop_time_stamp, the time of the reproduction start point of the title on the local time axis defined by chunkgroup is recorded. The value described in this field indicates the display time of picture designated by title_index of the title. In the field title_end_chunk_group_stamp, the time of the reproduction end point of the title on t he local time axis defined by chunk group is described. This value is identical to the value indicated by title_index indicating the reproduction end point of chunkgroup or the start point of title located immediately after the end point on the time axis.

In the field title_playback_time( ), the reproduction time of the title (time code value or number of sheets of frame or field) is recorded. In the field number_of_marks, the total number of marks being set in the title (except for title_index) is recorded. In the field mark_type, a kind of mark given to the desired position in the title is recorded as shown in FIG. 37. Mark is also used as the random access point in the title. In the field mark_chunk_group_time_stamp, the time stamps at the positions where the mark is set on the time axis of chunkgroup are recorded sequentially from the one having smaller size. The index having the same time stamp as the start point and end point of title may exist. In the field stuffing_bytes, the stuffing bytes are recorded and this field has a size of 8×n-bit(n≧0).

Next, chunkgroup and chunk shown in FIG. 21 to FIG. 24 will further be explained. In the file CHUNKGROUP_###.CGIT, definition of time axis of title, structure of chunk and process of non-continuous points included in the title are described.

The title is formed of various bit streams such as the bit stream not including video signal and the bit stream of including a DV(digital video) signal. In the DV format, the time axis is specified in unit of frame and since the format is different with reference to the STC (System Time Clock) of MPEG2video signal, it is impossible to control the bit stream of DV.

Therefore, the local time axis is assumed to be set in the title. This time axis does not depend on the stream forming the title. A boundary of the titles is set without any relation to the boundary of chunks. Therefore, it is more preferable to set the local time axis for aggregation of chunks including a plurality (desired number) of titles than the setting of such local time axis for every chunk (corresponding to bit stream on 1:1 basis) or every title.

In chunkgroup, single time axis is defined and chunk is attached thereon to define the display time of chunk. Namely, chunks are arranged in the chunkgroup under the condition that contents (byte stream) of bit stream file are developed on the time axis. A path is formed by arranging all chunks included in one bit stream file on the time axis. In the chunkgroup, a plurality of paths may be arranged. The path specifying the reproduction start time and end time of chunkgroup among paths is called the main path and the other paths are called the sub-path. The sub-path mainly indicates chunk of additionally recorded audio.

Since the connecting point of chunk does not always match the boundary of title, it does not indicate the attribute of title. However, when relationship between chunks is included in the attribute of each chunk, hierarchical contradiction is generated. Such non-continuous information is located at the intermediate point between chunk and title and such information is considered to be located at the hierarchy of chunkgroup.

In summary, the chunkgroup has information including arrangement of chunk on the time axis, chunk reproducing sequence and non-continuous points generated at the connecting point of the end of chunk and start of chunk generated next.

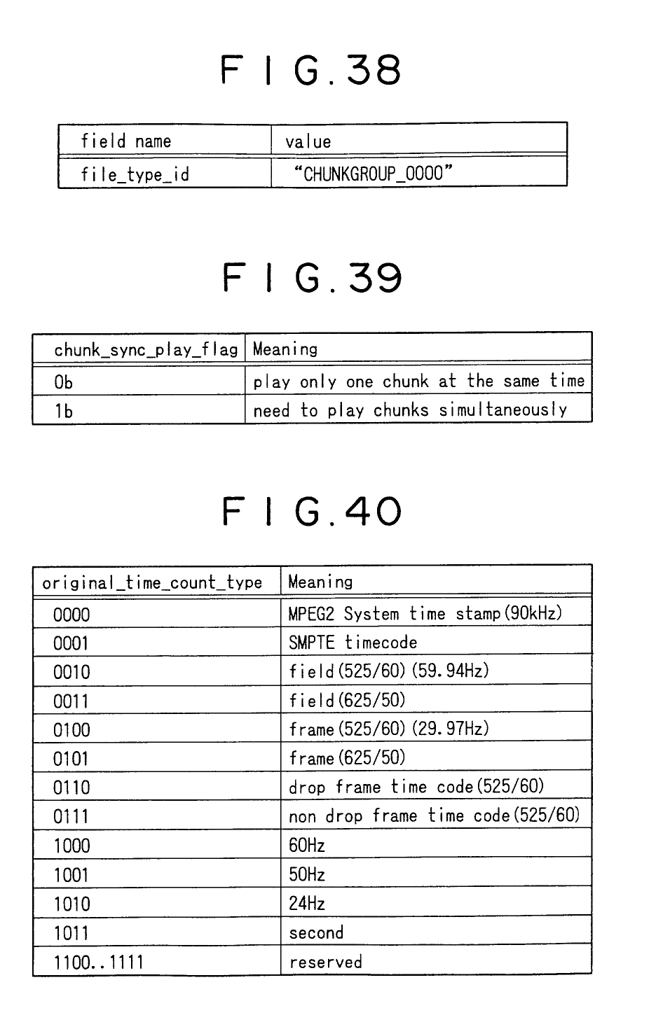

The field file_type_id of CHUNKGROUP_###.CGIT of FIG. 21 is an identifier, as shown in FIG. 38, indicating that such file is CHUNKGROUP_###.CGIT. This identifier is expressed by 16 characters conforming to ISO 646. In the field chunkgroup_time_base_flags, the flag regarding the reference counter of chunkgroup is recorded. Meanwhile, the start time of the reference time axis in the chunkgroup is recorded to the field chungroup_time_base_offset. This value is set to the counter which counts up the clock of 90 kHz and is expressed by 32 bits. The field text_block( ) is provided to store various texts and only the text item which is allowed to be used in the field text_block( ) is described.

As shown in FIG. 22, chunk_connection_info( ) is the file to record the peculiar point information (switching point of video, synchronization of video and audio) and specifies the connecting condition between chunks. At the peculiar point like the connecting point of chunks, the chunk must be changed in the course of GOP. The information about the area near the editing point is described in this file. The chunk does not belong to two or more chungroups.

The length of chunk_connection_info( ) expressed in unit of byte is recorded to chunk_connection_info_length. The total number of chunks used in the chunkgroup is recorded to number_of_chunks. Chunk_sync_play_flag is a flag, as shown in FIG. 39, indicating whether two or more chunks must be reproduced at the same time or not. The value 0 of this flag means reproduction of only one chunk and the value 1 means simultaneous reproduction of a plurality of chunks.

In the chunk_arrangement_info( ) of FIG. 23, the length of information of each chunk expressed in unit of byte (the length including the bytes from the leading byte of chunk_arrangement_info_length and to the end byte of transition_info( )) is recorded to chunk_arrangement info_length. To the chunk_info_file_id, the file_id of the object chunk_info_file is recorded.

The stream_id of the stream continuously recorded at the time of connection is recorded to chunk_switch_stream_id. As this id, for example, an id for identifying video or audio recorded to the packet header of MPEG2is used. To the presentation_start_cg_time_count, the time count value indicating the display start time of the relevant chunk in terms of the time in the chunkgroup is recorded. The display start time of chunk is expressed by the global time stamp defined in the chunkgroup. The relevant chunk is started to be displayed from this time in the chunkgroup. To the presentation_end_cg_count, the time count value indicating the display end time of this chunk in terms of the time in the chunkgroup is recorded. The display end time of chunk is expressed by the global time stamp defined in the chunkgroup.

As shown in FIG. 40, a kind of time count used in the stream is recorded to the original_time_count_type. For example, original_time_count_type is set to ‘0000’ for the stream of MPEG2video. To the number_of_start_original_time_count_extension, the number of time counts indicating the newly required start time is recorded when a plurality of time counts are required. To the number_of_end_original_time_count_extension, the number of time counts indicating the newly required end time is recorded when a plurality of time counts are required. To the presentation_start_original_time_count, the time or counter value within the stream corresponding to presentation_start_tg_time_count is recorded. To the presentation_end_original_time_count, the time or counter value within the stream corresponding to presentation_end_tg_time count is recorded.

To the tc_ext_attributes, the attribute for time_count_extension is recorded. To this time_count_extension, the information, for example, about the stream for the application can be set. To the start_original_time_count_extension, the start time or start counter value required for switching of chunk is recorded. This is an option and is used when it is required to record a plurality of times and counter values. To the end_original_time_count_extension, the end time or end counter value required for the switching of chunk is recorded. This is also an option and is used when it is required to record a plurality of times and counter value. To the transition_info( ), the information required for giving the special effect through the switching of chunk is recorded. For example, designation of chunk, switching time and a kind of special effect are described here.

As shown in FIG. 24, the file CHUNK_###.ABST is recording the characteristic point extracted from the bit stream forming the chunk with the sub-file number %%%%. In this file, the start byte position, length and attribute, etc. are described in every unit forming the bit stream such as GOP, Audio, etc. The GOP information, Audio frame information are summarized as one CHUNK_%%%%.ABST in every chunk (sub-file).

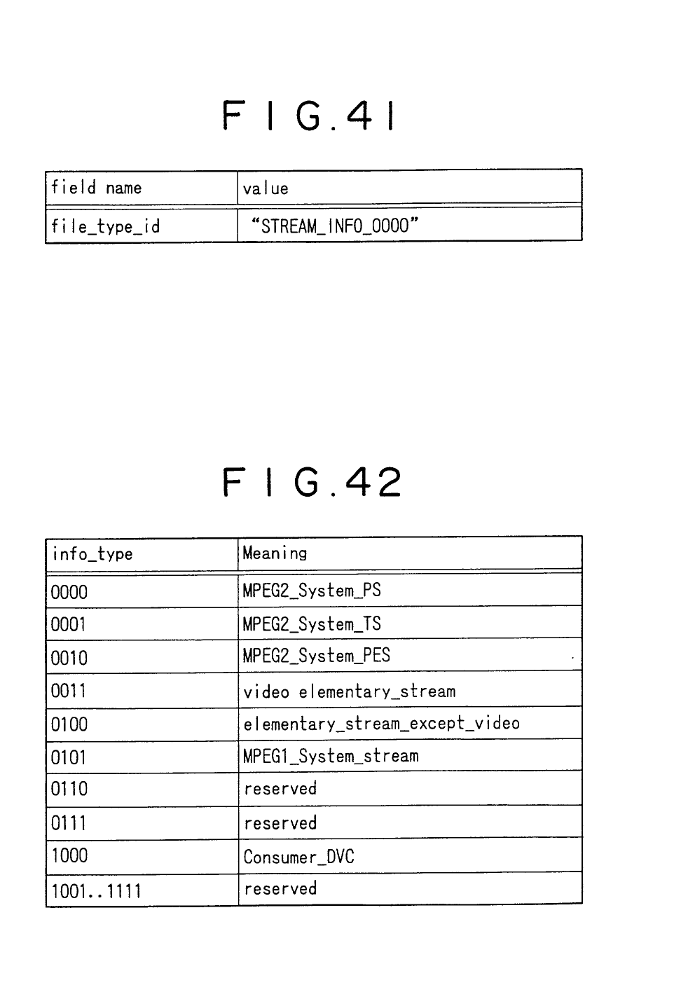

As shown in FIG. 41, the identifier indicating the file in which stream_info( ) is recorded is recorded by a character string of 16 characters conforming to ISO646 to the file_type_id of the file CHUNK_%%%%.ABST.

As shown in FIG. 42, a type of the following stream_info sown in FIG. 24 is recorded to info_type. Here, a kind of stream is identified. To the number_of_programs, the number of programs included in TS (Transport Stream) of MPEG2is recorded. In order to detect this number of programs, the PSI (Program Specific Information) must be read. For the item other than TS, this value becomes 1. To the number_of_streams, the number of streams used in this program is recorded. This value becomes equal, in the case of TS, to the number of different PIDs (packet identification). In the case of MPEG stream other than TS, the number of streams in different stream id is recorded.

To the stream_identifier, the stream id is recorded. In the case of TS, PID is used as the stream id.

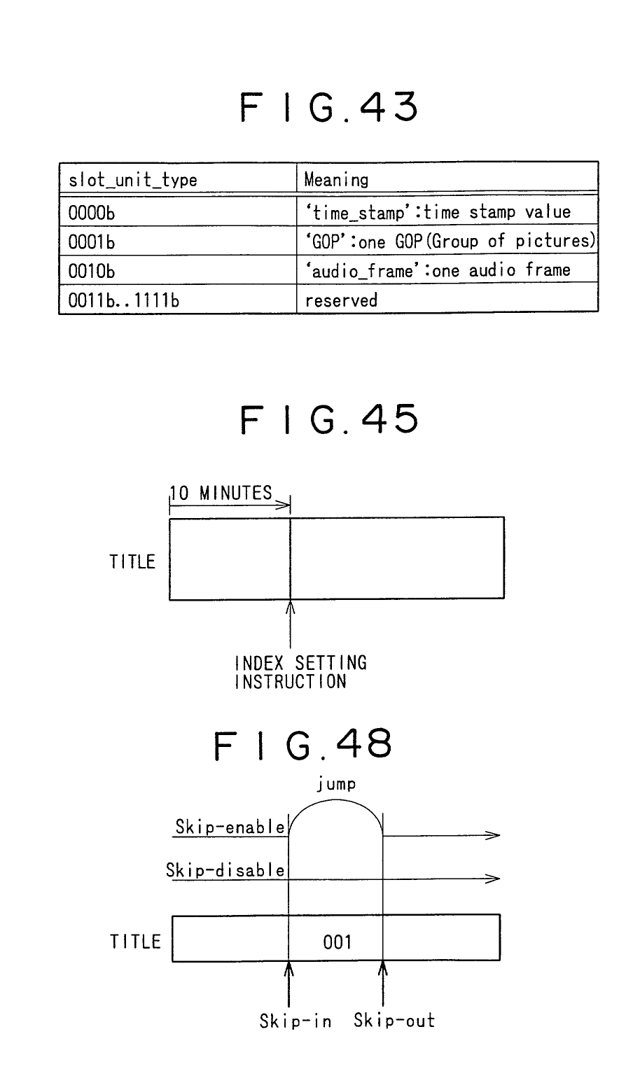

As shown in FIG. 43, a way of partitioning for dividing the stream in every constant interval is recorded to the slot_unit_type. When an index of dividing such as frame, field, etc. is time, time stamp value is used. To the field slot_time_length, the time corresponding to one slot is recorded. This value is expressed by the value of time stamp using the counter to count up the clock of 90 kHz. To the field number_of_slot, the number of slot_info( ) written in the file CHUNK_%%%%.ABST is recorded. To the field number_of_I_picture_in_a_slot, the number of I-picture included in the slot is recorded. This value is an inter equal to or larger than 1 and equal to or smaller than 15. However, the number I-picture included in the slot located immediately before the slot starting with GOP header may be smaller than this value. When the slot starting with the picture header of I-picture not immediately after the GOP header is set, this value is activated.

Next, the process to register the index point and the other marks on the optical disk 1 will be explained with reference to the flowchart of FIG. 44. In the step S1, a user manipulates an input section 14 to instruct reproduction of the position to set the mark. When the position to set the mark is reproduced, a user manipulates the input section 14 in the step S2 to instruct the setting of index at this position.

For example, as shown in FIG. 45, when a user instructs, in the step S1, the reproduction of the relevant position in such a case that the position to be accessed frequently is located at the area isolated by 10 minutes from the leading area of the predetermined title, CPU21 controls the optical head 2 to reproduce the optical disk 1. The data is reproduced through the optical head 2, RF and demodulating/modulating circuit, ECC circuit 4, switch 5, reading channel buffer 6 and decoder 7. The decoder 7 decodes the input data, outputs the audio data from the output terminal P2 and outputs and displays the video data to the display unit from the combining circuit 8 via the output terminal P1.

A user manipulates the input section 14 in the step S2 to instruct the setting of index in the timing when the position to set the index is reproduced.

When the setting of index is instructed, CPU21 calculates, in the step S3, the time up to the current position from the leading area of the title. In an example of FIG. 45, this time is 10 minutes.

Next, in the step S4, CPU21 adds 1 to the for sentence number_of_marks shown in FIG. 16. In the step S5, the predetermined kind of index is set to the mark_type in the loop and the time calculated in the step S3 is set to relative_time_stamp_in_title. For example, 0000b(index type 1) shown in FIG. 37 is set as mark_type and the time 10 minutes is set, in the case of an example FIG. 45, to relative_time_stamp_in_title. What kind of index should be set to mark_type depends on the designation by a user.

Next, in the step S6, CPU21 records title_info( ) (TITLE_###.VDR(FIG. 15)) to which the index is set in the step S5 to the optical disk 1.

Namely, in this case, TITLE_###.VDR is produced from title_info( ) being stored in RAM42 and it is then supplied and stored to the write timing buffer 11. The TITLE_###.VDR read therefrom is recorded to the optical disk 1 via the switch 5, ECC circuit 4, RF and demodulating/modulating circuit 3 and optical head 2.

As explained above, for example, when the queuing index is recorded, the queuing can be made easily using this queuing index. FIG. 46 shows an example of this process.

In other words, first, in the step S21, when a user instructs index jump by manipulating the input section 14, CPU21 searches the registered index point from title_info( ) (when the optical disk 1 is loaded to the optical disk apparatus, CPU21 causes the optical disk apparatus to reproduce, as explained above, VOLUME.TOC,TITLE_###.VDR recorded and then to store it to RAM24) and then controls, in the step S23, the OSD control circuit 9 to generate the data to display the index point and output and display to the display unit via the combining circuit 8 and output terminal P1. Thereby, the index point set by the process explained with reference to FIG. 44 is displayed on the display unit.

Therefore, in the step S24, a user selects the desired index point (the queuing point) from the index being displayed by manipulating the input section 14. When the predetermined index point is selected, CPU21 reads, in the step S25, the relative_time_stamp_in_title of the selected index point and also obtains, in the step S26, the address of the reproduction start point (index point) from the information of corresponding chunkgroup, chunk. When the address of index point is obtained, CPU21 controls the optical head 2 in the step S27 for making access to the index point and then starting the reproduction therefrom. As explained above, for example, it is now possible to queue the 10-minute position from the leading area of the TITLE shown in FIG. 45 and then to start the reproduction from this position.

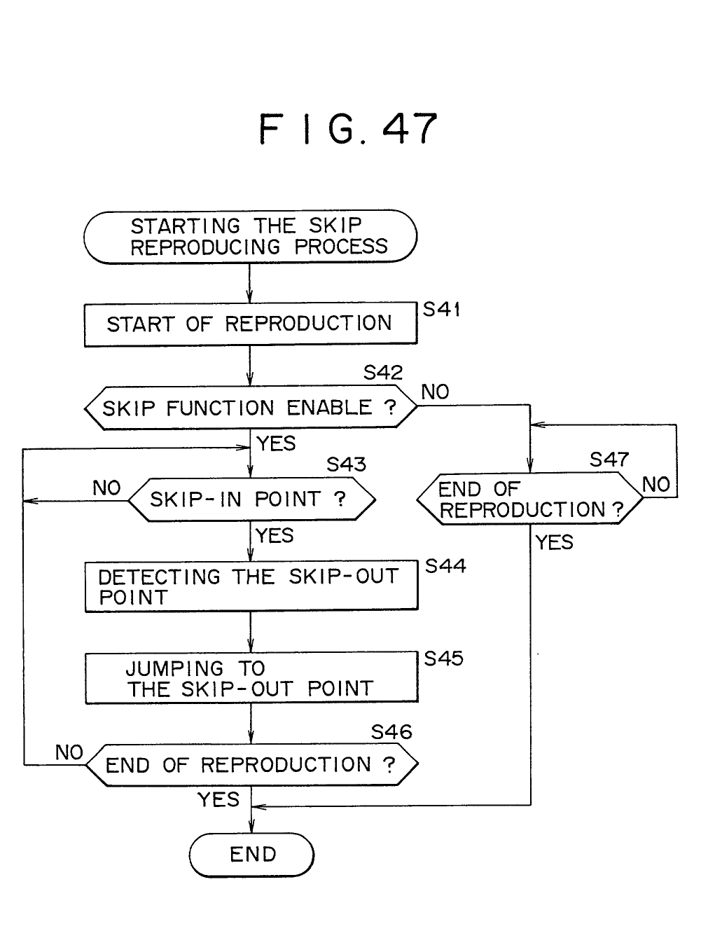

As shown in FIG. 27, the skip-in point (skip start point) and the skip-out point (skip destination point) can be registered as mark_type. When such skip-in point (1000b) and skip-out point (1001b) are registered, the process shown in the flowchart of FIG. 47 is executed.

Namely, when the reproducing process of the optical disk 1 is started in the step S41, CPU21 determines, in the step S42, whether the skip function enable mode is set or not. Namely, a user, when it is required to execute the skip in the skip-in point designated during the reproduction process, instructs previously the skip function enable mode by manipulating the input section 14. When it is not required to execute the skip, a user previously instructs the skip function disable mode.

When it is determined that the skip function enable mode is instructed in the step S42, CPU21 determines, in the step S43, whether the current reproducing position has reached the skip-in point or not. If the reproducing position does not yet reach the skip-in point, regular reproducing operation is continued until the reproducing position reaches the skip-in position. When it is determined, in the step S43, that the reproducing point has reached the skip-in point, CPU21 searches, in the step S44, the corresponding skip-out point and then jumps (skips) the reproducing point to the searched skip-out point in the step S45.

Thereby, if the skip function enable mode is instructed when the reproducing point has reached the skip-in point during the reproduction of TITLE_001, for example, as shown in FIG. 48, the reproducing point up to the skip-out point from the skip-in point is jumped and the reproduction is started again from the ship-out point.

Next, in the step S46, whether reproduction has completed or not is determined. If reproduction is not yet completed, the subsequent processes are repeated in the step S43. When reproduction is determined to be completed in the step S46, the process is completed.

On the other hand, when it is determined, in the step S42, the skip function enable mode is not yet set (skip function disable mode is set), CPU21 does not execute the skip process, executes the regular process and completes the process when the reproduction is completed in the step S47. In other words, in this case, as shown in FIG. 48, the reproducing point has reached the skip-in point, jump is not conducted and TITLE_001 is continuously reproduced.

Moreover, when 1010b is set as mark_type as shown in FIG. 37, the reproducing point is jumped to the end point of TITLE or to the start point of the next TITLE from the index point. When 1011b is set as mark_type, it indicates that there is a scene change there. When 1100b is set, an audio signal is muted from this position and when 1101b is set, the audio signal reaches the peak level at his position. When 1110b is set, a stationary image is reproduced at this position.

In above explanation, the present invention is applied to an optical disk apparatus, but the present invention can also be applied to recording or reproducing of information to the other storage medium.

As the program offering medium which can offer the computer programs to execute the processes explained above to users, it is possible to utilize the communication media such as network and satellite, in addition to the storage medium such as magnetic disk, CD-ROM and solid-state memory, etc.

As explained above, according to the recording apparatus, recording method and program offering medium of the present invention, since the designated position and kind are recorded to a storage medium, many kinds of indices can be recorded without limitation of format.

Moreover, according to the reproducing apparatus, reproducing method and program offering medium of the present invention, since reproduction of information from the recording medium is controlled corresponding to the position designating information and kind designating information reproduced from the storage medium, many kinds of indices can be reproduced without any limitation of the format and data reproduction may be realized in various manners.

According to the recording/reproducing apparatus and recording/reproducing method and program offering medium of the present invention, since the position designating information and kind designating information are recorded to a storage medium and reproduction of information from the storage medium can be controlled corresponding to the position designating information and kind designating information reproduced from the storage medium, many kinds of indices can be recorded or reproduced without limitation on the format.

In addition, according to the storage medium, since the position designating information and kind designating information are recorded, a storage medium which enables reproduction of many kinds of indices without limitation on the format can be realized.

What is claimed is:

1. A recording apparatus for recording information to a storage medium, comprising:
position designating means for designating information to said storage medium;
kind designating means for designating information recorded on said storage medium; and
recording means for recording, to said storage medium, the position designated by said position designating means and the kind designated by said kind designating means.

2. A recording apparatus according to claim 1, wherein said recording means records, at a time to an area of said storage medium, the position designated by said position designating means and the kind designated by said kind designating means.

3. A recording apparatus according to claim 1, wherein said position designating designates the position of said information from the leading area.

4. A recording apparatus according to claim 1, wherein said kind designating means designates, at least, the condition of said information at the position designated by said position designating means and the reproducing operation.

5. A recording method of the recording apparatus for recording information to a storage medium, comprising:
position designating step for designating the position of information recorded in said storage medium;
kind designating step for designating the kind of position designated by said position designating step; and
recording step for recording, to said storage medium, the position designated by said position designating step and the kind designated by said kind designating step.

6. A program offering medium for offering the computer readable programs to the recording apparatus to record the information to a storage medium for executing the processes including:
position designating step for designating the position of information recorded in said storage medium;
kind designating step for designating the kind of position designated by said position designating step; and
recording step for recording, to said storage medium, the position designated by said position designating step and the kind designated by said kind designating step.

7. A reproducing apparatus for reproducing information from a storage medium, comprising:
reproducing means for reproducing, from said storage medium, the position designating information for designating the position of information recorded to said storage medium and the kind designating information for designating the kind of position designated by said position designating information; and
control means for controlling reproduction of information from said storage medium corresponding to said position designating information and kind designating information reproduced by said reproducing means.

8. A reproducing apparatus according to claim 7, wherein said reproducing means reproduces said position designating information and said kind designating information recorded to an area of said storage medium.

9. A reproducing apparatus according to claim 7, wherein said position designating information designates the position of said information from the leading area.

10. A reproducing apparatus according to claim 7, wherein said kind designating information designates, at least, the condition of said information at the position designated by said position designating information and the reproducing operation.

11. A reproducing method comprising:
reproducing step for reproducing, from said storage medium, the position designating information for designating the position of information recorded to said storage medium and the kind designating information for designating kind of position designated by said position designating information; and
control step for controlling reproduction of information from said storage medium corresponding to said position designating information and said kind designating information reproduced by said reproducing step.

12. An program offering medium for offering, to the reproducing apparatus for reproducing information from a storage medium, the computer-readable programs for executing the processes including:
reproducing step for reproducing, from said storage medium, the position designating information for designating position of information recorded in said storage medium and the kind designating information for designating kind of position designated by said position designating information; and
control step for controlling reproduction of information from said storage medium corresponding to said position designating information and said kind designating information reproduced by said reproducing step.

13. A recording/reproducing apparatus for recording or reproducing information to/from a storage medium, comprising:
recording means for recording, to aid storage medium, the position designating information for designating position of information recorded on said storage medium and the kind designating information for designating kind of position designated by said position designating information;
reproducing means for reproducing, from said storage medium, said position designating information and said kind designating information recorded to said storage medium; and
control means for controlling reproduction of information from said storage medium corresponding to said position designating information and said kind designating information reproduced by said reproducing means.

14. A recording/reproducing method of recording/ reproducing apparatus for recording or reproducing information to/from a storage medium, comprising:
recording step for recording, to said storage medium, the position designating information for designating position of information recorded to said storage medium and the kind designating information for designating kind of position designated by said position designating information;
reproducing step for reproducing, from aid storage medium, the position designating information and said kind designating information recorded on said storage medium; and
control step for controlling reproduction of information from said storage medium corresponding to said position designating information and said kind designating information reproduced in said reproducing step.

15. A program offering medium for offering, to the recording/reproducing apparatus for recording or reproducing information to/from a storage medium, the computer-readable programs to execute the processes including:
recording step for recording, to said storage medium, the position designating information for designating position of information recorded on said storage medium and the kind designating information for designating kind of position designated by said position designating information;
reproducing step for reproducing, from said storage medium, the position designating information and said kind designating information recorded on said storage medium; and
control step for controlling reproduction of information from said storage medium corresponding to said position designating information and said kind designating information reproduced in said reproducing step.

16. A storage medium for recording or reproducing information, wherein the position designating information for designating position of information recorded to said storage medium and the kind designating information for designating kind of position designated by said position designating information are recorded.
